(19) United States
(12) Patent Application Publication
(10) Pub. No.: US 2020/0076645 A1
(43) Pub. Date: Mar. 5, 2020

(54) BRIDGE DEVICE AND INFORMATION PROCESSING APPARATUS INCLUDING BRIDGE DEVICE

(71) Applicant: CANON KABUSHIKI KAISHA, Tokyo (JP)

(72) Inventors: Yasutomo Tanaka, Toride-shi (JP); Daisuke Matsunaga, Tokyo (JP); Toshio Yoshihara, Kawasaki-shi (JP); Yasushi Shinto, Inagi-shi (JP)

(21) Appl. No.: 16/542,181

(22) Filed: Aug. 15, 2019

(30) Foreign Application Priority Data
Aug. 31, 2018 (JP) 2018-163190

(51) Int. Cl. H04L 12/46; G06F 13/40; G06F 12/06; G06F 12/0802

(52) U.S. Cl. CPC H04L 12/4625; G06F 12/0802; G06F 12/063; G06F 13/404

(57) ABSTRACT

A bridge device connected to a master device and a plurality of memory devices, and includes a reception unit configured to receive a command for controlling a memory device, a memory address in the memory device, and data via a same signal line, the command, the memory address, and the data being output from the master device, an output unit configured to output the command received by the reception unit to at least one of the memory devices, and a selection unit configured to select a memory device to perform processing of the command received by the reception unit from among the plurality of memory devices based on the memory address received from the master device by the reception unit.

### BACKGROUND OF THE INVENTION

### Field of the Invention

The present disclosure relates to a bridge device and an information processing apparatus including the bridge device.

### Description of the Related Art

In an information processing apparatus, a memory for storing operation logs of software executed by a central processing unit (CPU) is connected to a main bus of a controller via a memory controller.

The memory controller and the memory are connected by using a serial interface such as a Serial Peripheral Interface (SPI). Here, the memory controller operates as a master device, and the memory as a slave device to be controlled by the master device. According to the SPI standard, a master device can select a memory to communicate by asserting a chip select signal, and transmit signals to the selected memory for data read and write.

Japanese Patent Application Laid-Open No. 2006-304011 discusses a configuration that can output a plurality of chip select signals and in which a master device controls which of a plurality of memory devices to communicate. The master device discussed in Japanese Patent Application Laid-Open No. 2006-304011 selects a memory device to perform data transfer from the plurality of memory devices, and asserts the chip select signal corresponding to the memory device. After the assertion of the chip select signal corresponding to the memory device to perform data transfer with, the master device starts to output a command and data to the memory device to perform data transfer with.

A master device that performs communication in compliance with the SPI standard can be connected with a plurality of memory devices via a bridge device. The master device asserts a chip select signal to the bridge device to notify the bridge device of a start of communication. The master device inputs a command and memory address for controlling a memory device to the bridge device via signal lines for data transfer.

The bridge device starts to communicate with the memory devices based on the assertion of the chip select signal by the master device. However, the bride device is unable to determine which memory device to access from the chip select signal asserted by the master device.

### SUMMARY OF THE INVENTION

According to an aspect of the present disclosure, a bridge device connected to a master device and a plurality of memory devices includes a reception unit configured to receive a command for controlling a memory device, a memory address in the memory device, and data via a same signal line, the command, the memory address, and the data being output from the master device, an output unit configured to output the command received by the reception unit to at least one of the memory devices, and a selection unit configured to select a memory device to perform processing of the command received by the reception unit from among the plurality of memory devices based on the memory address received from the master device by the reception unit.

Further features of the present disclosure will become apparent from the following description of exemplary embodiments with reference to the attached drawings.

### BRIEF DESCRIPTION OF THE DRAWINGS

FIG. 1 is a diagram illustrating an example of a block diagram of an information processing apparatus according to a first exemplary embodiment.

FIG. 2 is a block diagram illustrating details of a controller unit according to the present exemplary embodiment.

FIGS. 3A and 3B are diagrams illustrating details of a bridge device according to the first exemplary embodiment.

FIGS. 4A and 4B illustrate examples of timing charts of signals for a write access and read access output in communication compliant with a Quad Serial Peripheral Interface (QSPI) according to the present exemplary embodiment.

FIG. 5 is a flowchart illustrating processing performed by a slave circuit according to the first exemplary embodiment.

FIG. 6 is a flowchart illustrating an example of write processing performed by the slave circuit according to the first exemplary embodiment.

FIG. 7 is a flowchart illustrating an example of read processing performed by the slave circuit according to the first exemplary embodiment.

FIG. 8 is a flowchart illustrating processing performed by a master circuit according to the first exemplary embodiment.

FIGS. 9A, 9B1 and 9B2, are timing charts each illustrating an example during the write processing and the read processing according to the first exemplary embodiment.

FIG. 10 is a diagram illustrating an example of details of a bridge device according to a second exemplary embodiment.

FIG. 11 is a timing chart illustrating an example during write processing according to the second exemplary embodiment.

FIG. 12 is a timing chart illustrating an example during read processing according to the second exemplary embodiment.

FIG. 13 is a flowchart illustrating processing performed by an address analysis circuit according to the second exemplary embodiment.

FIG. 14 is a diagram illustrating an example of details of a bridge device according to a third exemplary embodiment.

FIGS. 15A and 15B are timing charts each illustrating an example during write processing according to the third exemplary embodiment.

FIGS. 16A and 16B are timing charts each illustrating an example during read processing according to the third exemplary embodiment.

FIG. 17 including FIGS. 17A and 17B is a flowchart illustrating processing performed by an address analysis circuit according to the third exemplary embodiment.

FIG. 18 is a flowchart illustrating access transition processing to a next memory device, performed by the address analysis circuit according to the third exemplary embodiment.

### DESCRIPTION OF THE EMBODIMENTS

Bridge devices according to exemplary embodiments of the present disclosure will be described in detail below with reference to the accompanying drawings. Configurations described in the following exemplary embodiments are merely examples, and the present disclosure is not limited to the illustrated configurations.

A first exemplary embodiment for carrying out the present disclosure will be described below with reference to the drawings. Configurations described in the following first exemplary embodiment are merely examples, and the present disclosure is not limited to the illustrated configurations.

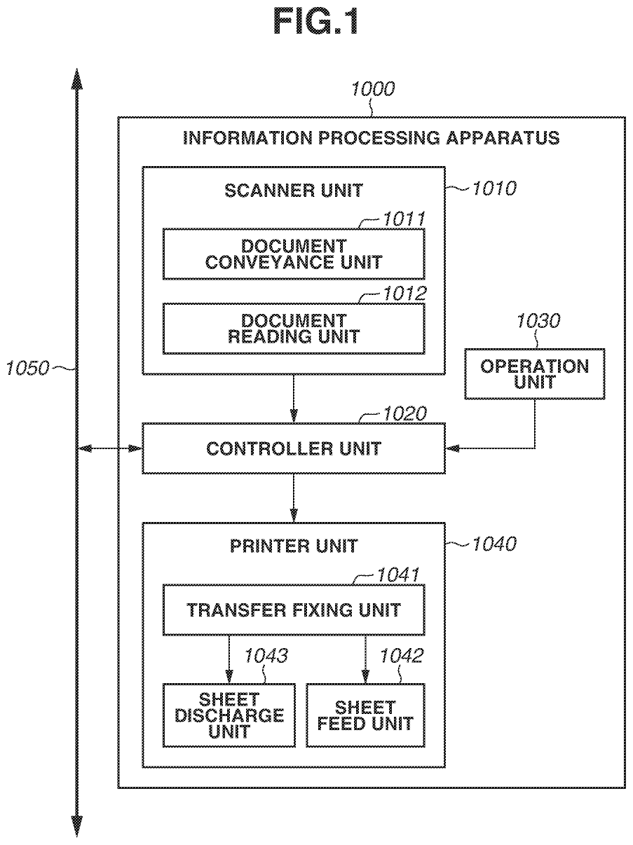

FIG. 1 is a block diagram illustrating an example of a configuration of a digital multifunction peripheral operating as an information processing apparatus 1000 according to the present exemplary embodiment. A scanner unit 1010 optically reads a document and converts the read document into image data. The scanner unit 1010 includes a document reading unit 1012 that includes a laser light source and lens for optically reading the document, and a document conveyance unit 1011 that includes a belt for conveying the document. A printer unit 1040 conveys a recording medium (sheet) and prints image data on the sheet as a visible image. The printer unit 1040 includes a sheet feed unit 1042 that feeds sheets, a transfer fixing unit 1041 that transfers an image to a sheet and fixes the image, and a sheet discharge unit 1043 that sorts printed sheets, staples the sorted sheets, and conveys the stapled sheets to outside the information processing apparatus 1000.

A controller unit 1020 is electrically connected to the scanner unit 1010 and the printer unit 1040. The controller unit 1020 is further connected to a network 1050, such as a local area network (LAN), Integrated Services Digital Network (ISDN), the Internet, and an intranet. If the user uses a copy function, the controller unit 1020 controls the scanner unit 1010 to obtain image data on a document, and controls the printer unit 1040 to print an image on a sheet and output the printed sheet. If the user uses a scan function, the controller unit 1020 controls the scanner unit 1010 to obtain image data on a document and convert the image data into code data, and transmits the code data to a host personal computer (PC) (not illustrated) via the network 1050. If the user uses a print function, the controller unit 1020 converts print data (code data) received from the host PC via the network 1050 into image data, and controls the printer unit 1040 to print an image on a sheet and output the printed sheet. The information processing apparatus 1000 also has a facsimile (FAX) reception function of receiving data from ISDN and printing the data, and a FAX transmission function of transmitting scanned data to ISDN. Processing execution instructions for such functions are called jobs. The information processing apparatus 1000 performs predetermined processing based on jobs corresponding to the functions. An operation unit 1030 is a user interface for the user to make input operations. For example, the operation unit 1030 includes a touch panel and various buttons.

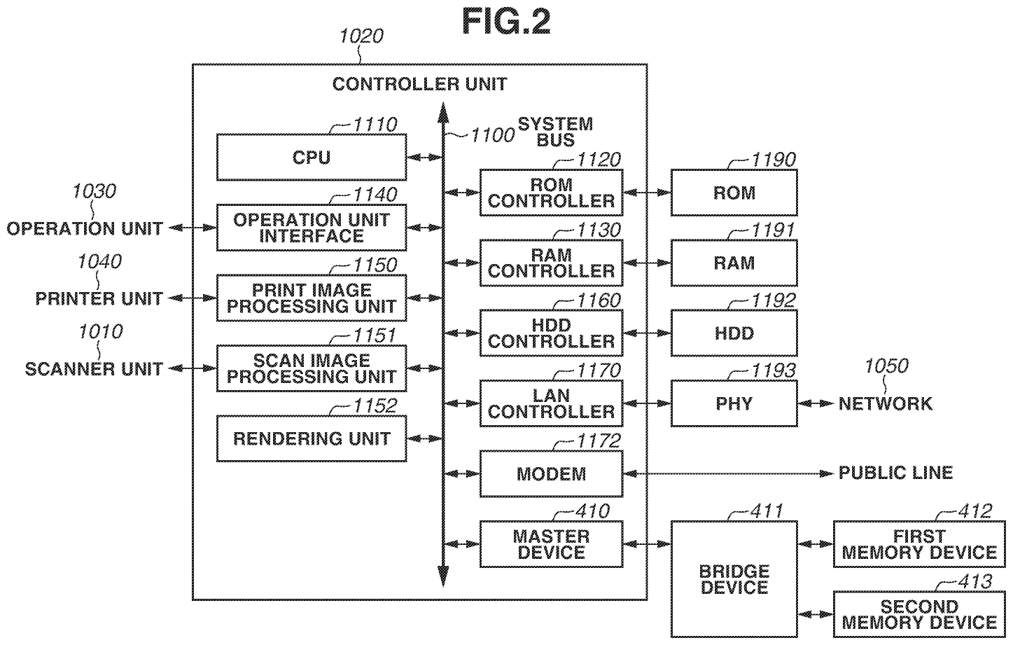

FIG. 2 is a block diagram illustrating an internal configuration of the controller unit 1020 according to the present exemplary embodiment. The components of the controller unit 1020 are described below.

A central processing unit (CPU) 1110 is a processor that controls the entire system. The CPU 1110 controls job processing, such as print processing and scan processing, in a centralized manner based on an operating system (OS) and control programs loaded into a random access memory (RAM) 1191.

A read-only memory (ROM) controller 1120 is a control module for accessing a ROM 1190 in which a system boot program is stored. When the information processing apparatus 1000 is powered on, the CPU 1110 accesses the ROM 1190 via the ROM controller 1120 and boots up.

A RAM controller 1130 is a control module for accessing the RAM 1191 that stores system control programs and image data. The RAM controller 1130 includes a register for setting and controlling the RAM 1191. The register is accessible by the CPU 1110. An operation unit interface 1140 controls acceptance of operation instructions made by the user operating the operation unit 1030 and display of operation results.

A scan image processing unit 1151 performs scanner-specific image processing on image data obtained by the scanner unit 1010. Examples of the scanner-specific image processing include shading correction processing, modulation transfer function (MTF) correction processing, gamma correction processing, and filter processing. The scan image processing unit 1151 has a function of detecting a synchronization signal having abnormal cycles due to the effect of electrostatic noise, masking the detected synchronization signal having abnormal cycles, and counting the number of synchronization signals having abnormal cycles.

A print image processing unit 1150 performs print-specific image processing intended for image data to be used by the printer unit 1040. Examples of the print-specific image processing include color space conversion processing, halftone processing, and gamma correction processing. The print image processing unit 1150 outputs the processed image data to which the print-specific image processing is applied to the printer unit 1040.

A hard disk drive (HDD) 1192 stores system software, application programs, image data, page information and job information corresponding to each piece of image data. The HDD 1192 is connected to a system bus 1100 via an HDD controller 1160, and writes and reads data based on instructions from the CPU 1110.

A LAN controller 1170 is connected to the network 1050 via a physical layer chip (PHY) 1193. The LAN controller 1170 inputs and outputs information such as image data from/to an external host computer.

A modem 1172 is connected to a not-illustrated public line, and performs data communication with an external FAX device when processing FAX transmission and FAX reception jobs. A rendering unit 1152 converts image data (page description language (PDL) data) received from the network 1050 via the LAN controller 1170 into bitmap data that the printer unit 1040 can handle.

A master device 410 is a control module for accessing a first memory device 412 and a second memory device 413 via a bridge device 411. Examples of the first and second memory devices 412 and 413 include a memory device having a Quad Serial Peripheral Interface (QSPI) interface (I/F). The bridge device 411 transfers data transferred from the master device 410 to the first and second memory devices 412 and 413. The QSPI is a serial peripheral interface (SPI), a communication method in which a master device and a slave device perform synchronous serial data transfer based on a clock signal supplied from the master device.

The first memory device 412 and the second memory device 413 are memory devices such as a ferroelectric random access memory (FRAM (registered trademark)) and a static random access memory (SRAM) having a QSPI I/F. In the present exemplary embodiment, the first and second memory devices 412 and 413 record logs of boot processing performed by the CPU 1110 and execution of programs.

In the present exemplary embodiment, the controller unit 1020 is mounted on a first printed circuit board. The bridge device 411, the first memory device 412, and the second memory device 413 are mounted on a second printed circuit board.

In the present exemplary embodiment, a plurality of memory devices can be connected to one master device 410 by using the bridge device 411 as illustrated in FIG. 2. The use of the bridge device 411 can thus increase the number of memory devices connected to the master device 410 without changing the configuration of the master device 410. In other words, by using the bridge device 411, the number of slave devices connected to the master device 410 can be increased to increase the memory capacity accessible to the master device 410.

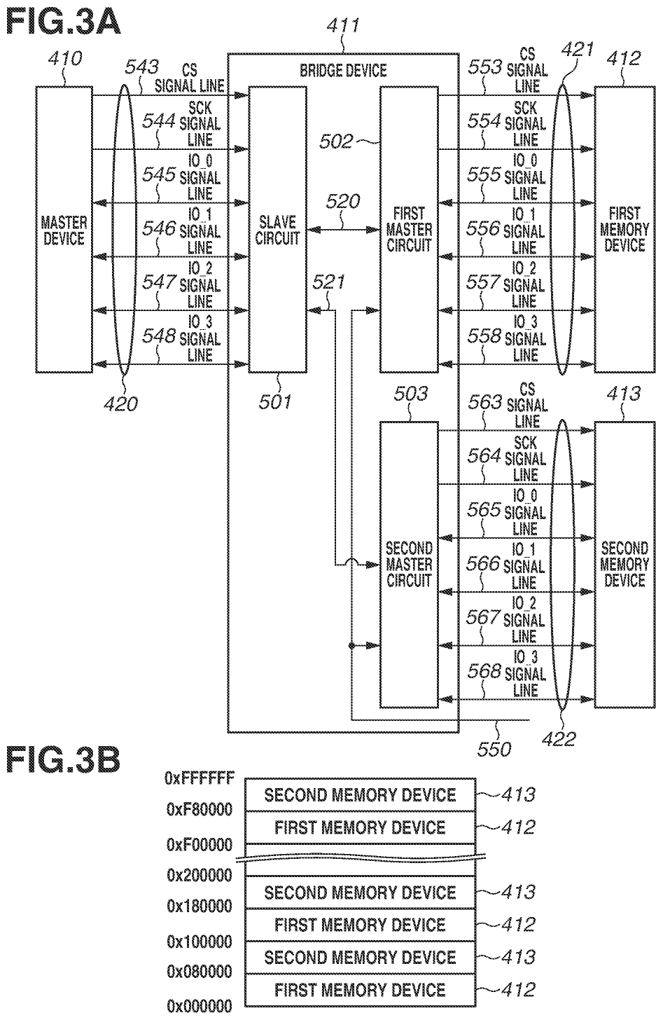

Details of the master device 410, the bridge device 411, the first memory device 412, and the second memory device 413 according to the present exemplary embodiment will be described with reference to FIG. 3A.

The bridge device 411 includes a slave circuit 501, a first master circuit 502, and a second master circuit 503. In the present exemplary embodiment, the bridge device 411 is described to be connected to two memory devices. However, the number of memory devices connected is not limited to the foregoing.

The master device 410 and the slave circuit 501 perform communication compliant with the QSPI standard by using the following six signal lines.

A chip select (CS) signal line 543 is a signal line that transmits a CS signal by which the master device 410 notifies the slave circuit 501 of a start of access of a device to be accessed. A serial clock (SCK) signal line 544 is a signal line that transmits a clock signal for synchronizing data transfer which is performed by using IO_0 to IO_3 signal lines 545 to 548. In the communication compliant with the QSPI standard, the clock signal is output only during data transfer. After the completion of data transfer, the master device 410 negates the CS signal and stops outputting the clock signal.

The IO_0 to IO_3 signal lines 545 to 548 are signal lines for the master device 410 and the slave circuit 501 to perform data transfer. The slave circuit 501 includes a counter that counts the number of input clocks of the clock signal after the CS signal is asserted by the master device 410. The slave circuit 501 determines whether a received signal is an opcode, an address, or data by referring to the value of the counter. The slave circuit 501 stores data received during two clocks after the assertion of the CS signal by the master device 410 as a command (opcode), and stores data received between the third and eighth clocks as an address. The slave circuit 501 stores data received after eight clocks as read- or write-related data. In such a manner, the same signal lines can be used to input and output a command, an address, and data. The slave circuit 501 can identify a memory address to be accessed using the signal received from the master device 410.

A first interface 420 is an interface between the master device 410 and the slave circuit 501. The first interface 420 includes the CS signal line 543, the SCK signal line 544, and the IO_0 to IO_3 signal lines 545 to 548 described above.

The slave circuit 501 and the first master circuit 502 are connected with a signal line 520. The signal line 520 is a signal line for inputting the signal input to the slave circuit 501 via the CS signal line 543 and the IO_0 to IO_3 signal lines 545 to 548 to the first master circuit 502. In FIG. 3, the signal line 520 includes a plurality of signal lines for transmitting such signals.

The slave circuit 501 and the second master circuit 503 are connected via a signal line 521. Details of the signal line 521 are similar to those of the signal line 520. A description thereof will thus be omitted.

An external clock signal line 550 is a signal line for supplying a clock signal different from that of the SCK signal line 544 to the first and second master circuits 502 and 503. In the following exemplary embodiment, the clock signal supplied from the master device 410 to the slave circuit 501 and the clock signal supplied from the external clock signal line 550 have the same frequency. It will be understood that the clock signal supplied from the master device 410 to the slave circuit 501 and the clock signal supplied from the external clock signal line 550 may have different frequencies.

The first master circuit 502 is connected to the first memory device 412. The first master circuit 502 and the first memory device 412 transfer data in compliance with the QSPI standard. A CS signal line 553, an SCK signal line 554, and IO_0 to IO_3 signal lines 555 to 558 are similar to the signal lines between the master device 410 and the slave circuit 501. A description thereof will thus be omitted. A second interface 421 is an interface between the first master circuit 502 and the first memory device 412. The second interface 421 includes the CS signal line 553, the SCK signal line 554, and the IO_0 to IO_3 signal lines 555 to 558 mentioned above.

The second master circuit 503 is connected to the second memory device 413. The second master circuit 503 and the second memory device 413 transfer data in compliance with the QSPI standard. The configuration between the second master circuit 503 and the second memory device 413 is similar to that between the first master circuit 502 and the first memory device 412. A description thereof will thus be omitted. A third interface 422 is an interface between the second master circuit 503 and the second memory device 413. The third interface 422 includes a CS signal line 563, an SCK signal line 564, and IO_0 to IO_3 signal lines 565 to 568.

FIG. 3B is a memory map of the bridge device 411 as seen from the master device 410 according to the present exemplary embodiment. In the present exemplary embodiment, the memory devices connected to the bridge device 411 are two 512-Kbyte FRAMs. On the memory map illustrated in FIG. 3B, 0x000000 to 0x07FFFF are memory addresses in the first memory device 412, and 0x080000 to 0x0FFFFF are memory addresses in the second memory device 413. As illustrated in FIG. 3B, addresses 0x100000 and later are configured to mirror the areas of 0x000000 to 0x0FFFFF. Specifically, addresses subsequent to 0x0FFFFF are configured so that 0x100000 to 0x17FFFF are for the first memory device 412 and 0x180000 to 0x1FFFFF are for the second memory device 413. Addresses in a 512-Kbyte memory device are expressed in 19 bits. In the present exemplary embodiment, the master device 410 outputs a 24-bit address, whereas the first and second memory devices 412 and 413 ignore the 20th and higher bits of the address.

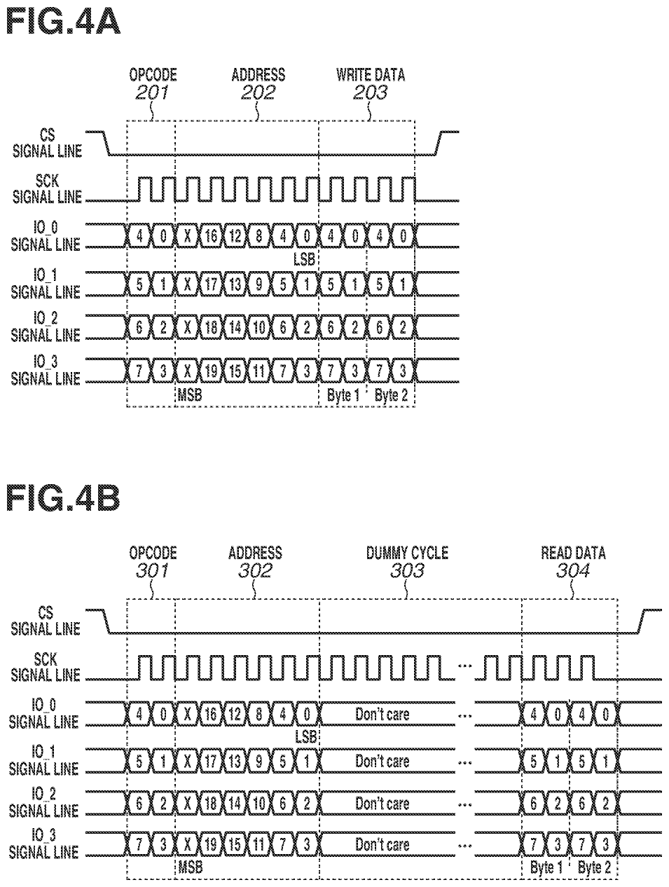

FIG. 4A is a timing chart when the master device 410, the first master circuit 502, or the second master circuit 503 makes a write access to its slave circuit or device in compliance with the QSPI standard. The signals compliant with the QSPI have three phases including an opcode 201, an address 202, and write data 203. The numerals written in the blocks representing pieces of data transferred via the IO_0 to IO_3 signal lines indicate the order of bits in which the slave device analyzes the data.

The opcode 210 is a signal indicating what processing is to be performed on a QSPI slave. The opcode 201 is transmitted by eight bits in two clocks after the assertion of the CS signal. The zeroth bit of the IO_0 signal is the least significant bit of the signal transmitted in the phase of the opcode 201. The seventh bit of the IO_3 signal is the most significant bit.

The address 202 is a signal indicating the input/output destination of data. During a write access to a memory device, the address 202 is a signal for designating the address to start writing. The address 202 is designated in six clocks by 24 bits transmitted after the opcode 201. Both the first memory device 412 and the second memory device 413 used in the present exemplary embodiment are FRAMs having a capacity of 512 Kbytes. In other words, the bridge device 411 is connected with 1 Mbytes of FRAMs. In the present exemplary embodiment, the access destination of a memory device is thus designated by using the zeroth to nineteenth, 20 bits of the 24-bit signal. The bridge device 411 disables the 20th to 23rd bits of the signal. In the present exemplary embodiment, the disabled pieces of data are marked with X.

The write data 203 is a data signal to be written to the first memory device 412 or the second memory device 413. In the phase of the write data 203, the data to be written can be continuously output. If write data is continuously output, the data is written while incrementing the address to be accessed, starting at the address designated by the address 202.

FIG. 4B is a timing chart when the master device 410, the first master circuit 502, or the second master circuit 503 makes a read access to its slave circuit or device in compliance with the QSPI standard. The numerals in the blocks indicate what number bits the respective pieces of data are.

A read command includes the phases of an opcode 301, an address 302, a dummy cycle 303, and read data 304. The opcode 301 and the address 302 are similar to those of a write command. A description thereof will thus be omitted. The dummy cycle 303 is a phase indicating a wait time needed for the slave circuit or slave device to read data. The number of dummy clocks determined for the connected slave device in advance is set in the master-side device. When outputting a read command, the master-side device outputs a preset number of cycles of clock signal as the dummy cycle 303. The master-side device disables data received during the dummy cycle 303, if any. In the phase of the read data 304, data stored at the address designated by the address 302 is obtained. In the read data 304, data can be continuously obtained. The data is obtained from the first memory device 412 or the second memory device 413 while incrementing the address, starting at the address designated by the address 302.

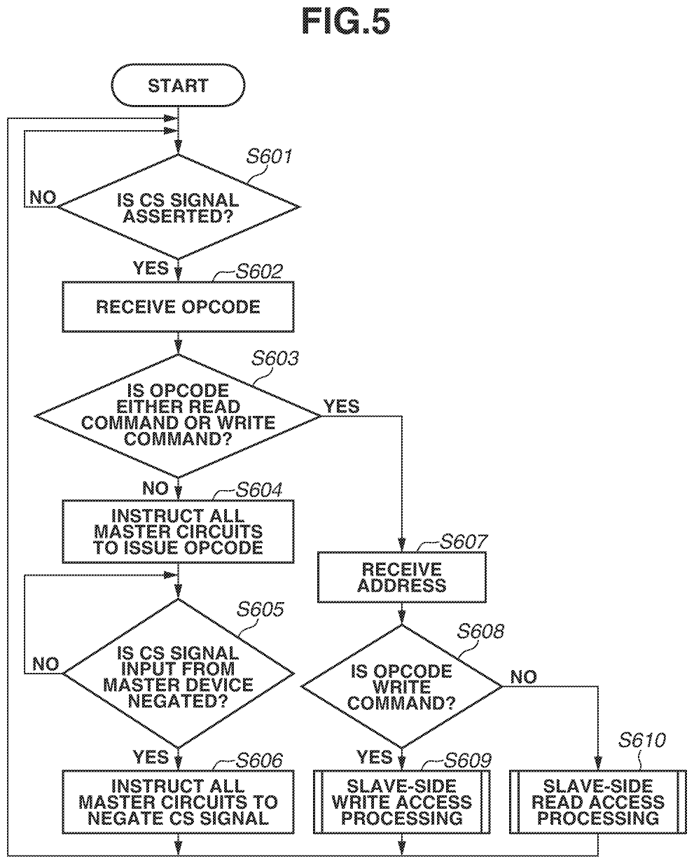

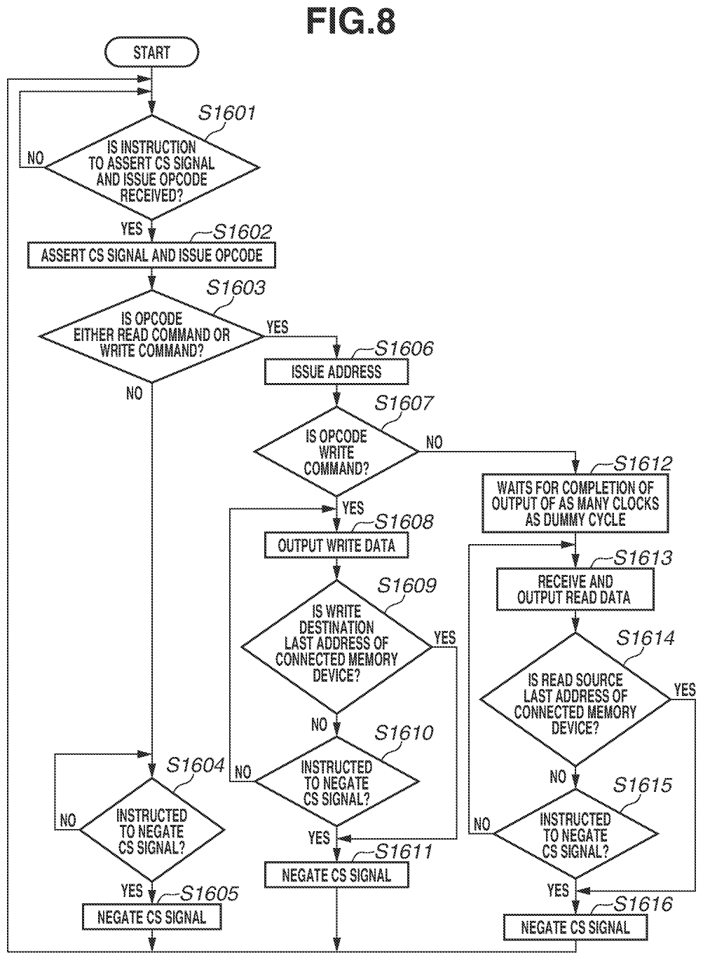

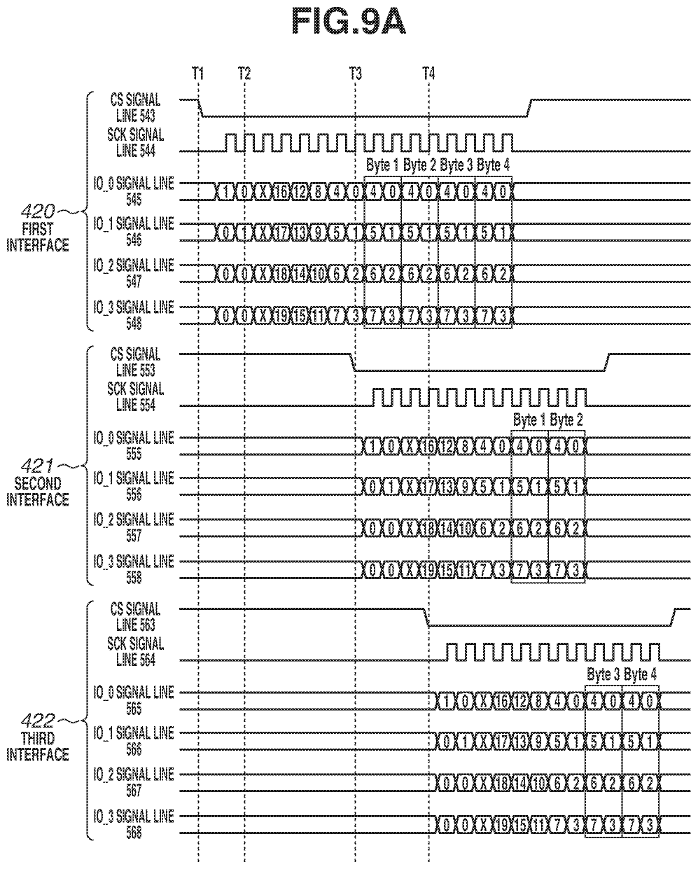

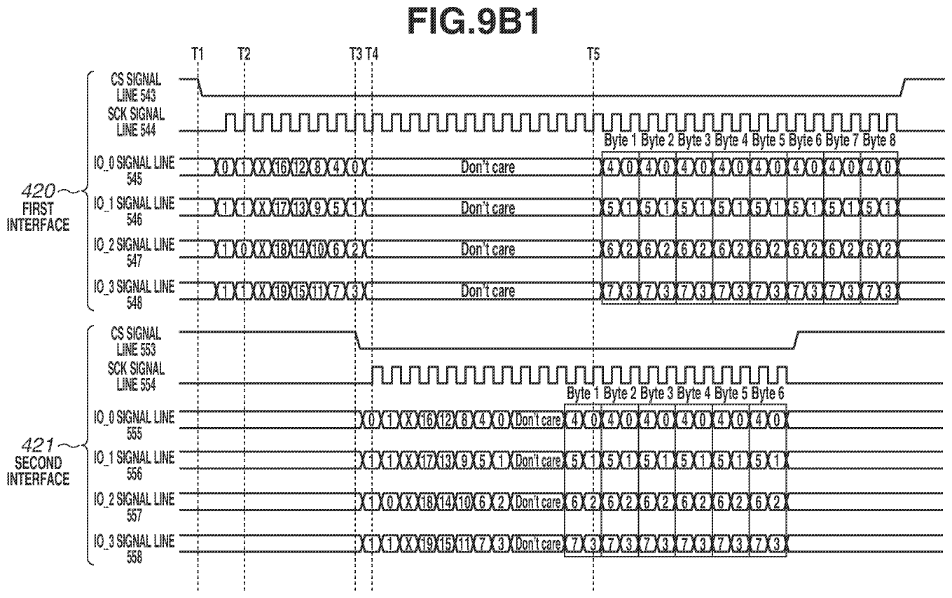

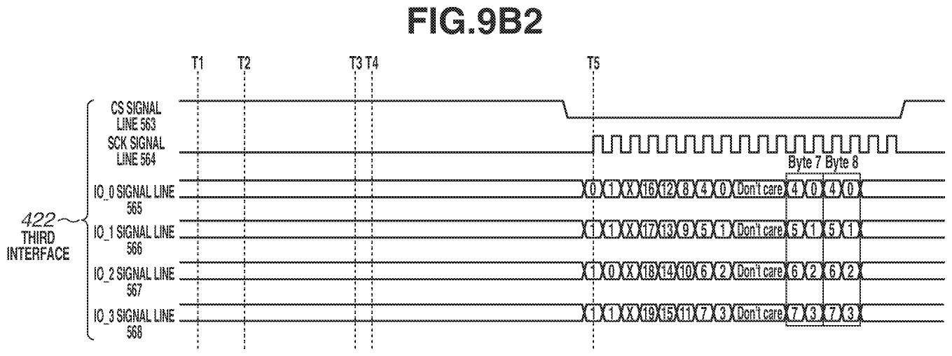

Processing performed by the bridge device 411 will be described with reference to FIGS. 5 to 9B. FIGS. 5 to 7 are flowcharts illustrating processing performed by the slave circuit 501 in the bridge device 411. FIG. 8 is a flowchart illustrating processing performed by the first master circuit 502 in the bridge device 411. FIG. 9A illustrates a timing chart when write processing is performed. FIGS. 9B1 and 9B2 illustrate a timing chart when read processing is performed.

The processing illustrated in FIG. 5 is started in response to the information processing apparatus 1000 being powered on to supply power to the bridge device 411. The processing is continued until the power supply to the bridge device 411 is ended. In the present exemplary embodiment, the following processing is described to be performed by the slave circuit 501. The CPU 1110 may implement the processing by executing a program loaded in the RAM 1191.

In step S601, the slave circuit 501 determines whether the CS signal input from the master device 410 is asserted. At time T1 of FIG. 9A, the slave circuit 501 detects that the signal (CS signal) of the CS signal line 543 becomes a low level and is asserted. The slave circuit 501 thereby determines that communication with the master device 410 is started. If the CS signal is not asserted (NO in step S601), the processing returns to step S601. If the CS signal is asserted (YES in step S601), the processing proceeds to step S602.

In step S602, the slave circuit 501 receives an opcode via the IO_0 to IO_3 signal lines 544 to 548, and stores the received opcode into a not-illustrated buffer. At time T2 of FIG. 9A, the slave circuit 501 completes the reception of the opcode. In step S603, the slave circuit 501 determines whether the received opcode is either a read command or a write command. If the received opcode is neither a read command nor a write command (NO in step S603), the processing proceeds to step S604. If the received opcode is either a read command or a write command (YES in step S603), the processing proceeds to step S607.

In step S604, i.e., if the received opcode is neither a read command nor a write command, the slave circuit 501 notifies all the connected master circuits, in this case the master circuits 502 and 503, of the opcode, and instructs the master circuits 502 and 503 to issue the opcode. Examples of opcodes other than write and read commands include a command for giving an instruction to enable writing to the memory devices 412 and 413, such as a write enable command. In step S605, the slave circuit 501 determines whether the CS signal input from the master device 410 is negated. If the CS signal is not negated (NO in step S605), the processing returns to step S605. If the CS signal is determined to be negated (YES in step S605), the processing proceeds to step S606. In step S606, the slave circuit 501 instructs all the connected master circuits, in this case the master circuits 502 and 503, to negate their CS signal. The slave circuit 501 issues the instruction to negate the CS signal via the signal lines 520 and 521. The processing then returns to step S601.

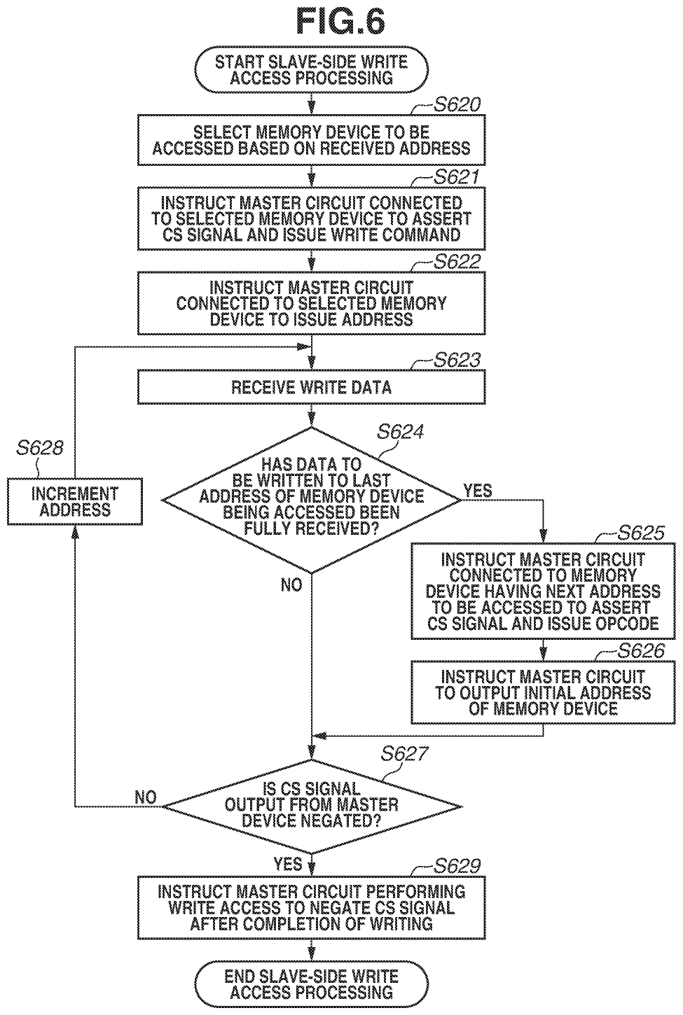

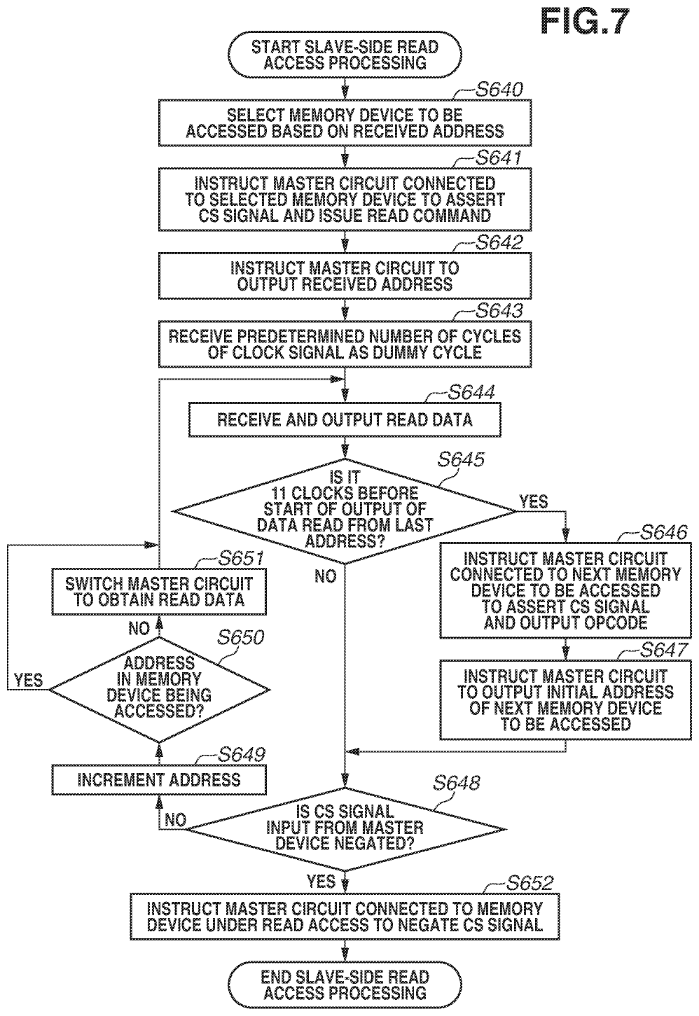

In step S607, i.e., if the received opcode is determined to be a write command or a read command in step S603, the slave circuit 501 receives an address from the master device 410 and stores the address in a not-illustrated buffer. In step S608, the slave circuit 501 determines whether the received opcode is a write command. If the received opcode is a write command (YES in step S608), the processing proceeds to step S609. In step S609, the slave circuit 501 performs the processing illustrated in FIG. 6. If the received command is a read command (NO in step S608), the processing proceeds to step S610. In step S610, the slave circuit 501 performs the processing illustrated in FIG. 7.

FIG. 6 illustrates the processing to be performed in the case where the slave circuit 501 receives a write command. In step S620, the slave circuit 501 analyzes the address received in step S607, and selects the memory device to be accessed. The slave circuit 501 refers to the 19th bit of the address received by time T3 of FIG. 9A. If the value of the 19th bit is 0, the slave circuit 501 determines to access the first memory device 412. On the other hand, if the value of the 19th bit is 1, the slave circuit 501 determines to access the second memory device 413. In step S621, the slave circuit 501 instructs the master circuit connected to the memory device selected in step S620 to assert its CS signal and issue the opcode received in step S602. For example, if the memory device selected based on the received address is the first memory device 412, the slave circuit 501 instructs the first master circuit 502, via the signal line 520, to assert the CS signal and issue a write command. In step S622, the slave circuit 501 instructs the master circuit connected to the selected memory device to issue the address received in step S607. In step S623, the slave circuit 501 receives write data from the master device 410, and transfers the write data to the master circuit selected in step S620. In step S624, the slave circuit 501 determines whether data to be written to the last address of the memory device being accessed has been fully received from the master device 410.

If the data to be written to the last address of the memory device has been fully received (YES in step S624), the processing proceeds to step S625. In step S625, the slave circuit 501 instructs the master circuit connected to the memory device having the next address to be accessed to assert its CS signal and issue the opcode. At time T4 of FIG. 9A, the slave circuit 501 instructs the second master circuit 503 to assert its CS signal and output the opcode. In step S626, the slave circuit 501 further instructs the master circuit accessed in step S625 to output the initial address of the memory device. In the present exemplary embodiment, the bridge device 411 buffers data output from the master device 410 for eight clocks, and outputs the buffered data to the slave devices. By starting to access the next memory device at timing when the data to be written to the last address of the preceding memory device is output, the bridge device 411 can quickly start writing to the next memory device after the completion of writing to the preceding memory device.

If the address of the write destination is not the last address of the memory device in step S624 (NO in step S624), the processing proceeds to step S627. In step S627, the slave circuit 501 determines whether the CS signal output from the master device 410 is negated. If the CS signal is not negated (NO in step S627), the processing proceeds to step S628. In step S628, the slave circuit 501 increments the address of the write destination. The processing then returns to step S623. If the CS signal is negated (YES in step S627), the processing proceeds to step S629. In step S629, the slave circuit 501 instructs the master circuit performing the write operation to negate the CS signal after the completion of the writing. What is described above is the operation during a write access.

Next, processing to be performed when the slave circuit 501 makes a read access will be described with reference to FIG. 7.

In step S640, the slave circuit 501 analyzes the address received in step S607 and selects the memory device to be accessed. At time T3 of FIGS. 9B1 and 9B2, the slave circuit 501 selects the memory device to be accessed. The method for determining which memory device to access is similar to that of FIG. 6. In step S641, the slave circuit 501 instructs the master circuit connected to the selected memory device to assert its CS signal and issue a read command. At time T4 of FIGS. 9B1 and 9B2, the slave circuit 501 instructs the first master circuit 502 to assert its CS signal and output the opcode. In step S642, the slave circuit 501 instructs the first master circuit 502 to issue the received address to the first memory device 412 after the read command. In step S643, the slave circuit 501 receives a predetermined number of cycles of clock signal from the master device 410 as a dummy cycle 303.

In step S644, the slave circuit 501 obtains read data from the master circuit connected to the selected memory device, and outputs the read data to the master device 410. In step S645, the slave circuit 501 determines whether it is 11 clocks before a start of output of data read from the last address of the memory device. If it is 11 clocks before the start of output of the data read from the last address of the memory device (YES in step S645), the processing proceeds to step S646. In step S646, the slave circuit 501 instructs the master circuit connected to the next memory device to be accessed to assert its CS signal and output the opcode.

In the present exemplary embodiment, it takes eight clocks to output an opcode and an address, and three clocks to output a dummy cycle. Data thus starts being read 11 clocks after a master circuit starts accessing a memory device. The slave circuit 501 therefore needs to instruct the master circuit connected to the next memory device to be accessed to start setting (outputting) the opcode and the address 11 clocks before the start of output of the data stored at the last address. In FIGS. 9B1 and 9B2, six bytes of data is read from the first memory device 412 before data starts being read from the second memory device 413. The slave circuit 501 then instructs the second master circuit 503 to set the opcode and the address at time T5 that is 11 clocks before the start of output of the sixth byte. Based on the instruction, the master circuit 503 asserts the CS signal and starts to set the opcode. In step S647, the slave circuit 501 further instructs the master circuit to issue the initial address of the next memory device to be accessed after the read command.

In step S648, the slave circuit 501 determines whether the CS signal input from the master device 410 is negated. If the CS signal is not negated (NO in step S648), the processing proceeds to step S649. In step S649, the slave circuit 501 increments the address of the read source. In step S650, the slave circuit 501 determines whether the incremented address is an address in the memory device being accessed. If the incremented address is an address in the memory device being accessed (YES in step S650), the processing returns to step S644. If, in step S650, the incremented address is not an address in the memory device being accessed (NO in step S650), the processing proceeds to step S651. In step S651, the slave circuit 501 switches the master circuit to obtain read data to the master circuit connected to the memory device designated by the incremented address. The slave circuit 501 obtains read data from the signal line 520 or 521. In step S651, the slave circuit 501 switches the value of a selector that controls which signal line to obtain read data from.

In step S648, if the CS signal is negated (YES in step S648), the processing proceeds to step S652. In step S652, the slave circuit 501 instructs the master circuit connected to the memory device under read access to negate the CS signal. The processing during a read access is thereby completed.

In the foregoing flowchart, the memory device about to start being accessed is described to be set with the opcode and the address at timing 11 clocks before the data stored at the last address of the preceding memory device starts to be output. However, how many clocks before the start of output of the data stored at the last address of the preceding memory device the opcode and the address start to be output is not limited to the foregoing value. The access to the memory device having started to be accessed before may be completed before the setting of the opcode and the address to the next memory device.

FIG. 8 is a flowchart illustrating the processing of the first and second master circuits 502 and 503 when accessed from the slave circuit 501. Since both the first and second master circuits 502 and 503 make similar operations, the following description is given by using the first master circuit 502 as an example. In the present exemplary embodiment, the following processing is described to be performed by the first master circuit 502 in the bridge device 411. However, the CPU 1110 may perform the following processing.

In step S1601, the first master circuit 502 determines whether an instruction to assert the CS signal and issue the opcode is received from the slave circuit 501. If no instruction to assert the CS signal and issue an opcode is received (NO in step S1601), the processing returns to step S1601. If the instruction to assert the CS signal and issue an opcode is received (YES in step S1601), the processing proceeds to step S1602. In step S1602, the first master circuit 502 sets the CS signal line 553 to a low level, and outputs an opcode to the IO_0 to IO_3 signal lines 555 to 558.

In step S1603, the first master circuit 502 determines whether the issued opcode is either a write command or a read command. If the issued opcode is a command other than a write command or a read command (NO in step S1603), the processing proceeds to step S1604. In step S1604, the first master circuit 502 determines whether the first master circuit 502 is instructed by the slave circuit 501 to negate the CS signal. If the first master circuit 502 is not instructed by the slave circuit 501 to negate the CS signal (NO in step S1604), the processing returns to step S1604. If the first master circuit 502 is instructed by the slave circuit 501 to negate the CS signal (YES in step S1604), the processing proceeds to step S1605. In step S1605, the first master circuit 502 negates the CS signal. The processing returns to step S1601.

If the opcode issued in step S1603 is either a write command or a read command (YES in step S1603), the processing proceeds to step S1606. In step S1606, the first master circuit 502 issues the address received from the slave circuit 501 to the first memory device 412. The address the first master circuit 502 issues here is the same as that received by the slave circuit 501. In step S1607, the first master circuit 502 determines whether the issued opcode is a write command. If the issued opcode is a write command (YES in step S1607), the processing proceeds to step S1608. In step S1608, the first master circuit 502 outputs write data to the first memory device 412. In step S1609, the first master circuit 502 determines whether the write destination is the last address of the first memory device 412. If the write destination is not the last address of the first memory device 412 (NO in step S1609), the processing proceeds to step S1610. Meanwhile, if the write destination is the last address of the first memory device 412 (YES in step S1609), the processing proceeds to step S1611.

In step S1610, the first master circuit 502 determines whether the first master circuit 502 is instructed by the slave circuit 501 to negate the CS signal. If the first master circuit 502 is not instructed to negate the CS signal (NO in step S1610), the processing returns to step S1608. If the first master circuit 502 is instructed to negate the CS signal (YES in step S1610), the processing proceeds to step S1611. In step S1611, the first master circuit 502 negates the CS signal output to the first memory device 412.

In step S1607, if the opcode is not a write command, i.e., the issued opcode is a read command (NO in step S1607), the processing proceeds to step S1612. In step S1612, the first master circuit 502 waits for the completion of output of as many clocks as a dummy cycle. In step S1613, after the output of as many clocks as a dummy cycle is completed, the first master circuit 502 receives read data from the first memory device 412 and outputs the read data to the slave circuit 501. In step S1614, the first master circuit 502 determines whether the address of the read source is the last address of the first memory device 412. If the address of the read source is not the last address of the first memory device 412 (NO in step S1614), the processing proceeds to step S1615. Meanwhile, if the address of the read source is the last address of the first memory device 412 (YES in step S1614), the processing proceeds to step S1616.

In step S1615, the first master circuit 502 determines whether the first master circuit 502 is instructed by the slave circuit 501 to negate the CS signal. If the first master circuit 502 is not instructed to negate the CS signal (NO in step S1615), the processing returns to step S1613. In step S1613, the first master circuit 502 receives read data. If the first master circuit 502 is instructed to negate the CS signal (YES in step S1615), the processing proceeds to step S1616. In step S1616, the first master circuit 502 negates the CS signal output to the first memory device 412. The processing then returns to step S1601.

By using such a bridge device 411, the number of memory devices which is more than the number of memory devices connectable to the master device 410 can be connected.

According to the present exemplary embodiment, in a read access, the setting of the opcode and address into the next memory device to be accessed is described to be started 11 clocks before the slave circuit 501 starts to output the read data read from the last address of the preceding memory device. However, the opcode and address may be set into the next memory device after the slave circuit 501 completes outputting the read data read from the last address of the preceding memory device.

In the first exemplary embodiment, no opcode or address is output to a memory device until the slave circuit 501 determines using the address received from the master device 410 which master circuit to access. This causes an idle time between when the master device 410 starts to output an opcode and when the memory device starts operation. A second exemplary embodiment is directed to reducing the time from when the master device 410 starts to output an opcode to when the memory device starts operation.

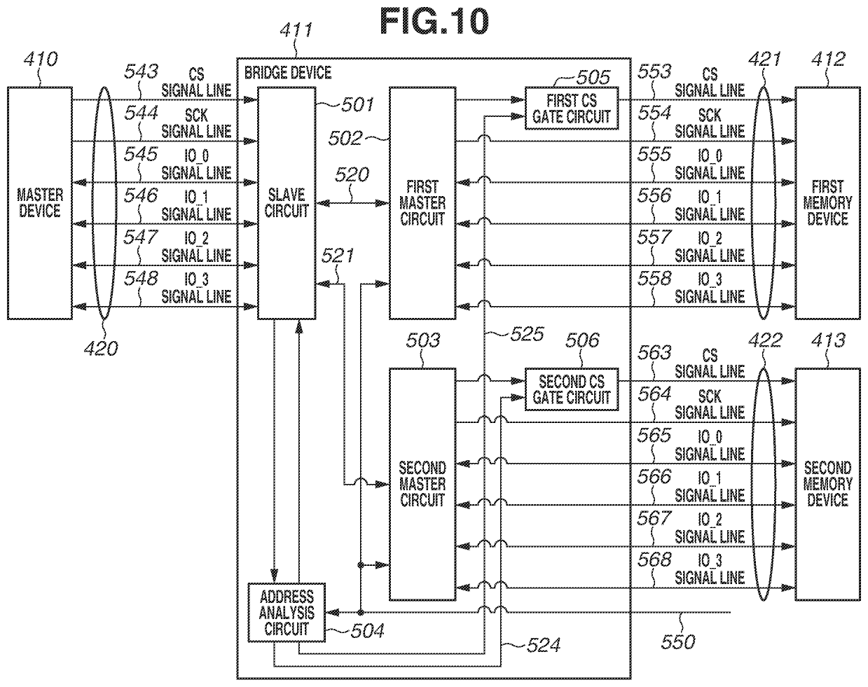

FIG. 10 is a block diagram illustrating a bridge device 411 according to the second exemplary embodiment. Similar blocks to those of the first exemplary embodiment are designated by the same reference numerals. Only differences from the first exemplary embodiment will be described here.

An address analysis circuit 504 receives the CS signal and the input/output signals from the slave circuit 501 and determines whether to gate the CS signal by using CS gate circuits to be described below. The address analysis circuit 504 also instructs the first master circuit 502 and the second master circuit 503 to output an opcode and an address. The address analysis circuit 504 includes a counter for counting the number of clocks input from the master device 410. The address analysis circuit 504 can determine that the signals of what numbered clock are input from when the CS signal has been asserted by the master device 410, by referring to the value of the counter. For example, a signal received during two clocks from when the CS signal has been asserted by the master device 410 is an opcode. A signal received between the third and eighth clocks indicates an address. A signal received at and after the ninth clock is a signal related to a read or write access. In such a manner, the address analysis circuit 504 can identify the memory address to be accessed using the signal received from the master device 410.

A first CS gate circuit 505 is a circuit for gating the CS signal output from the first master circuit 502 to the first memory device 412. For example, the first CS gate circuit 505 is a logic circuit, such as an OR circuit. The first CS gate circuit 505 switches whether to gate the CS signal output from the first master circuit 502 based on an output from the address analysis circuit 504. A second CS gate circuit 506 is a circuit for gating the CS signal output from the second master circuit 503 to the second memory device 413. Like the first CS gate circuit 505, the second CS gate circuit 506 gates the CS signal output from the second master circuit 503 based on an output of the address analysis circuit 504.

Signal lines 524 and 525 are signal lines that connect the address analysis circuit 504 with the first CS gate circuit 505 and the second CS gate circuit 506. Whether to gate the CS signals output from the respective master circuits 502 and 503 is switched by the address analysis circuit 504 changing the outputs to the signal lines 524 and 525.

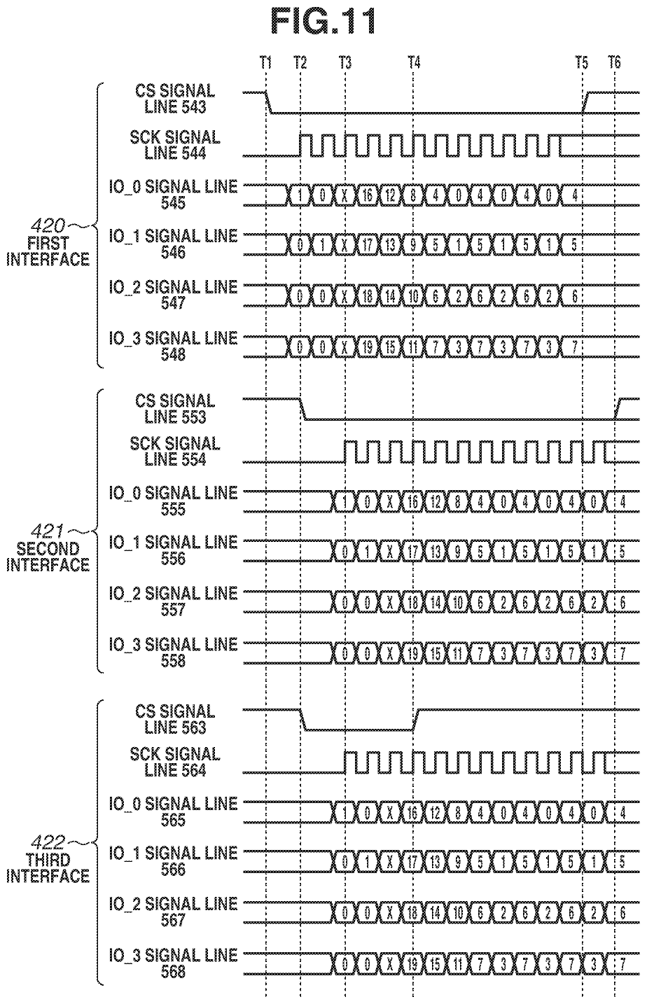

An operation of the bridge device 411 according to the second exemplary embodiment will be described with reference to the timing chart of FIG. 11. The following description is given by using a case where the master device 410 writes data to the first memory device 412 as an example.

At time T1, the master device 410 asserts the signal on the CS signal line 543. At time T2, the master device 410 starts to output the opcode. At time T3, the master device 410 starts to input an address to the slave circuit 501. At time T3, the first and second master circuits 502 and 503 start to output the opcode to the respective memory devices 412 and 413. In the present exemplary embodiment, the bridge device 411 needs two clocks to receive and output an opcode. The output of the first and second master circuits 502 and 503 therefore lags behind that of the master device 410 by two clocks.

The input address is input to the first master circuit 502, the second master circuit 503, and the address analysis circuit 504. At time T4, the value of the 19th bit of the address is input to the first master circuit 502, the second master circuit 503, and the address analysis circuit 504. The address analysis circuit 504 stores a relationship between the value of the 19th bit of an address and the memory device to which the address corresponds. At time T4, the address analysis circuit 504 refers to the value of the 19th bit, and determines whether the address output from the master device 410 is an address in the first memory device 412 or an address in the second memory device 413.

If the address output from the master device 410 is an address in the first memory device 412, the address analysis circuit 504 negates the CS signal output from the second master circuit 503. As illustrated at time T4, the CS signal 563 between the second master circuit 503 and the second memory device 413 is negated, whereby the access from the second master circuit 503 to the second memory device 413 is stopped.

As illustrated in the foregoing timing chart, if the master device 410 makes a write access, the first and second master circuits 502 and 503 output the input from the master device 410 with a delay of two clocks. The address analysis circuit 504 gates the CS signals output from the first and second master circuits 502 and 503 depending on the memory device to be accessed so that no CS signal is input to the memory device to not be accessed, whereby the communication with the memory device to not be accessed is ended. The bridge device 411 then communicates with only the memory device selected based on the address designated by the master device 410.

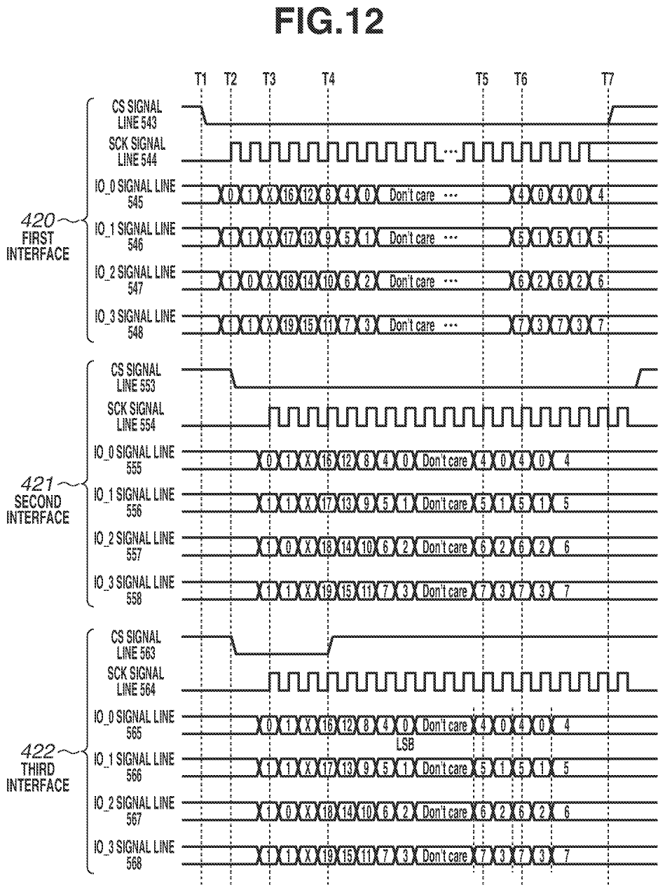

Next, operation when the master device 410 outputs a read command will be described with reference to FIG. 12. At time T1, the master device 410 asserts the CS signal. At time T2, the master device 410 starts to output the opcode. At time T2, the first and second master circuits 502 and 503 assert their CS signals and start to communicate with the first and second memory devices 412 and 413. At time T3, the master device 410 starts to output an address. The address output from the master device 410 at time T3 is input to the address analysis circuit 504, the first master circuit 502, and the second master circuit 503. At time T4, the value of the 19th bit of the address is input to the address analysis circuit 504, the first master circuit 502, and the second master circuit 503. The address analysis circuit 504 checks whether the value of the 19th bit is 0 or 1, and determines that the address is an address of which memory device, the first memory device 412 or the second memory device 413. Suppose that the master device 410 outputs an address of the first memory device 412 here. At time T4, the address analysis circuit 504 gates the CS signal output from the second master circuit 503 connected to the second memory device 413 to not be accessed. The communication between the second master circuit 503 and the second memory device 413 is thereby ended.

At time T5, the first master circuit 502 obtains read data from the first memory device 412. At time T6, the slave circuit 501 outputs the read data read from the first memory device 412 to the master device 410. At time T7, the CS signal is negated to end the communication between the master device 410 and the slave circuit 501.

By the foregoing operation, in a read access, the time it takes for the master device 410 to obtain read data from a memory device after the master device 410 issues a command to start communication with the memory device can be reduced.

In the second exemplary embodiment, the opcode is output to each memory device as described above before the reception of the address from the master device 410 is completed and the memory device to be accessed is determined. This can reduce the time before the memory device starts to be accessed, compared to the case where the address output from the master device 410 is received and the memory device to be accessed is determined before the bridge device 411 outputs the opcode.

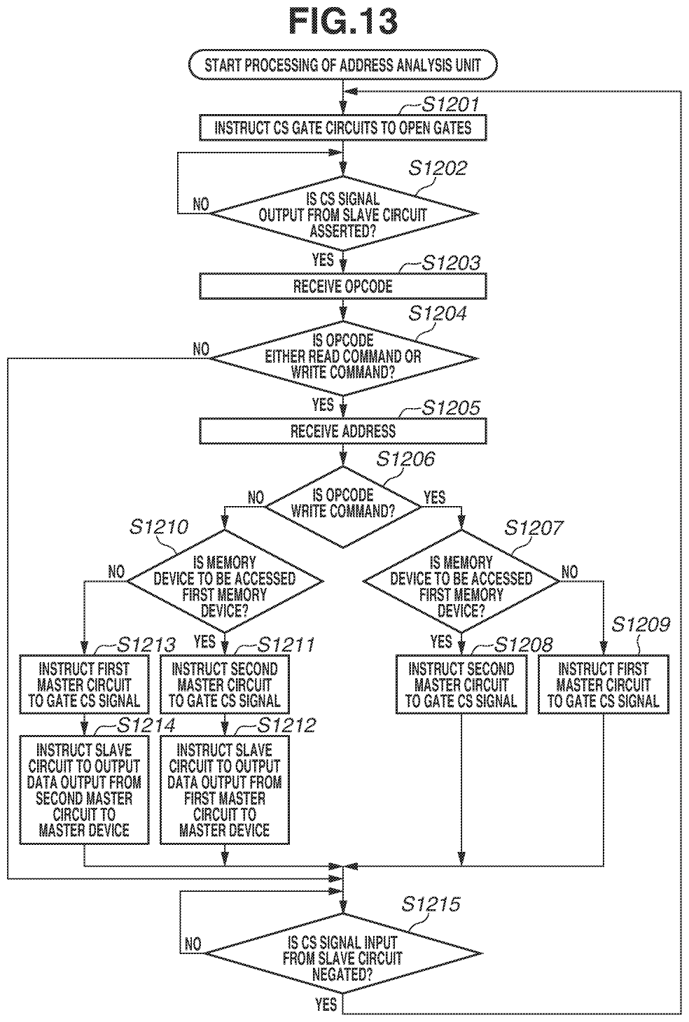

Next, the operation of the address analysis circuit 504 according to the second exemplary embodiment will be described with reference to FIG. 13. The processing illustrated in FIG. 13 is started in response to power-on of the information processing apparatus, and repeatedly performed until the information processing apparatus is powered off. In the present exemplary embodiment, the following processing is described to be performed by circuits such as an application specific integrated circuit (ASIC). However, the CPU 1110 may implement the following processing by executing a program.

In step S1201, the address analysis circuit 504 instructs the first and second CS gate circuits 505 and 506 to open their gates. The address analysis circuit 504 sets the signals of the signal lines 524 and 525 to a low level. The CS signal input from the slave circuit 501 to the first and second master circuits 502 and 503 is thereby input to the first and second memory devices 412 and 413 without being gated.

In step S1202, the address analysis circuit 504 determines whether the CS signal output from the slave circuit 501 is asserted to a low level. If the CS signal is not asserted (NO in step S1202), the processing returns to step S1202. If the CS signal is asserted (YES in step S1202), the processing proceeds to step S1203.

In step S1203, the address analysis circuit 504 receives an opcode from the slave circuit 501. The opcode is the same as that the slave circuit 501 outputs to the first and second master circuits 502 and 503. The address analysis circuit 504 receives the eight bits of data in two clocks, and stores the opcode in a not-illustrated register.

In step S1204, the address analysis circuit 504 determines whether the received opcode is either a read command or a write command. If the received opcode is neither a read command nor a write command (NO in step S1204), the processing proceeds to step S1215 to be described below. If the received opcode is either a read command or a write command (YES in step S1204), the processing proceeds to step S1205. In step S1205, the address analysis circuit 504 starts receiving an address. In step S1205, the address analysis circuit 504 receives the address and stores the received address in a not-illustrated register. After the 19th bit of the address is stored in the register, the processing proceeds to step S1206. The address analysis circuit 504 further receives address bits lower than the 19th bit and stores the address bits in a not-illustrated register in parallel with the following processing.

In step S1206, the address analysis circuit 504 determines whether the opcode received in step S1203 is a write command. If the opcode is a write command (YES in step S1206), the processing proceeds to step S1207. If the opcode is a read command (NO in step S1206), the processing proceeds to step S1210.

In step S1207. i.e., if the opcode is a write command, the address analysis circuit 504 determines whether the memory device to be accessed is the first memory device 412 based on the value of the 19th bit of the address received in step S1205. If the memory device to be accessed is the first memory device 412 (YES in step S1207), the processing proceeds to step S1208. In step S1208, the address analysis circuit 504 sets the input signal to the second CS gate circuit 506 to a high level so that the CS signal output from the second master circuit 503 is gated. If the memory device to be accesses is the second memory device 413 (NO in step S1207), the processing proceeds to step S1209. In step S1209, the address analysis circuit 504 sets the input signal to the first CS gate circuit 505 to the high level so that the CS signal output from the first master circuit 502 is gated. After the processing of step S1208 or S1209, the processing proceeds to step S1215 to be described below.

In step S1210, i.e., if the opcode is determined to be a read command in step S1206, the address analysis circuit 504 also determines whether the memory device to be accessed is the first memory device 412 based on the value of the 19th bit of the address received in step S1205. If the memory device to be accessed is the first memory device 412 (YES in step S1210), the processing proceeds to step S1211. In step S1211, the address analysis circuit 504 sets the input signal to the second CS gate circuit 506 to the high level so that the CS signal output from the second master circuit 503 is gated. In step S1212, the address analysis circuit 504 instructs the slave circuit 501 to output the data output from the first master circuit 502 to the master device 410. In step S1212, the address analysis circuit 504 controls the value of a selector that controls which of the signal lines 520 and 521 the slave circuit 501 outputs the data obtained through to the master device 410.

In step S1213, i.e., if the memory device to be accessed is the second memory device 413, the address analysis circuit 504 sets the input signal to the first CS gate circuit 505 to the high level so that the CS signal output from the first master circuit 502 is gated. In step S1214, the address analysis circuit 504 instructs the slave circuit 501 to output the data output from the first master circuit 502 to the master device 410. In step S1214, the address analysis circuit 504 controls the value of the selector that controls which of the signal lines 520 and 521 the slave circuit 501 outputs the data obtained through to the master device 410. After step S1212 or S1214, the processing proceeds to step S1215.

In step S1215, the address analysis circuit 504 determines whether the CS signal input from the slave circuit 501 is negated. If the level of the CS signal input from the slave circuit 501 is high, the address analysis circuit 504 determines that the CS signal is negated. If the CS signal is not negated (NO in step S1215), the processing returns to step S1215. If the CS signal is negated (YES in step S1215), the data transfer between the master device 410 and the first or second memory device 412 or 413 is considered to be completed and the processing returns to step S1201.

In the second exemplary embodiment, the bridge device 411 outputs the opcode to both the first and second memory devices 412 and 413 before the memory device designated by the address input from the master device 410 is determined. This can reduce the time from when the master device 410 starts to access the bridge device 411 to when the first or second memory device 412 or 413 starts being accessed. The time needed for data transfer between the master device 410 and the first and second memory devices 412 and 413 is thus reduced.

In the second exemplary embodiment, in steps S1208, S1209, S1211, and S1213 of FIG. 13, the CS signals supplied from the respective master circuits to the memory devices to not be accessed are gated to gate the CS signals input to the memory devices. This prevents failure to function normally such as reading of data from a memory device different from the one designated by the address output from the master device 410 and writing of data to a different memory device.

The second exemplary embodiment has been described by using the case where the access destination in a single access from the master device 410 does not range over a plurality of memory devices as an example. A burst access is a method for accessing consecutive addresses by a single access. If burst access-capable QSPI is used, the memory device to be accessed can change during a single access. A third exemplary embodiment describes the case where the memory device to be accessed changes during a single access.

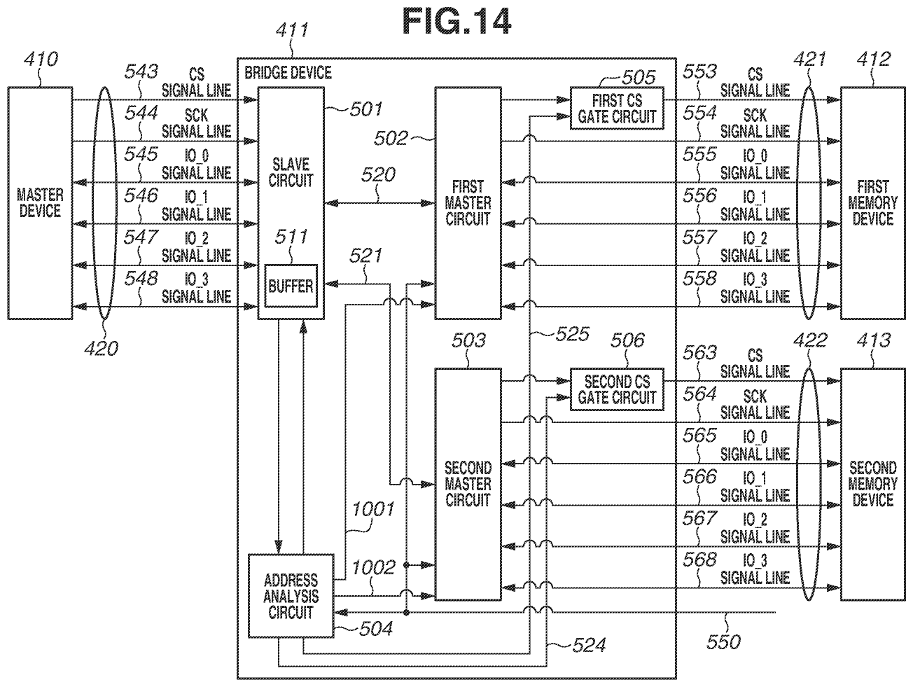

FIG. 14 is a diagram illustrating a detailed configuration of a bridge device 411 according to the third exemplary embodiment. Similar components to those of the second exemplary embodiment are designated by the same reference numerals. Only differences from the second exemplary embodiment will be described here. The bridge device 411 according to the third exemplary embodiment includes a signal line 1001 that inputs a signal output from the address analysis circuit 504 to the first master circuit 502. The signal line 1001 is a signal line for instructing the first master circuit 502 to output an opcode and address in a case where the access destination of the master device 410 transitions from the second memory device 413 to the first memory device 412. The bridge device 411 according to the third exemplary embodiment further includes a signal line 1002 for inputting a signal output from the address analysis circuit 504 to the second master circuit 503. The signal line 1002 is a signal line for instructing the second master circuit 503 to output an opcode and address in a case where the access destination of the master device 410 transitions from the first memory device 412 to the second memory device 413. With this configuration, the signal lines 1001 and 1002 enables the bridge device 411 according to the third exemplary embodiment to implement an access across a plurality of memory devices from the master device 410.

The slave circuit 501 of the bridge device 411 according to the third exemplary embodiment further includes a buffer 511. The buffer 511 is a buffer for storing data that is output from the master device 410 and to be output to the first and second master circuits 502 and 503 as much as one clock.

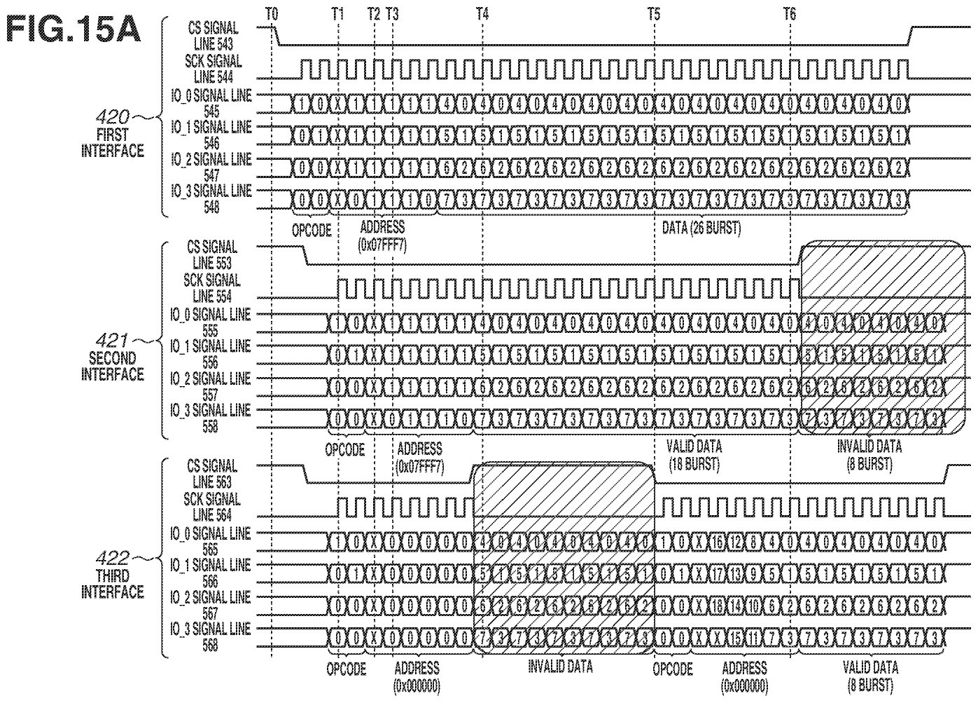

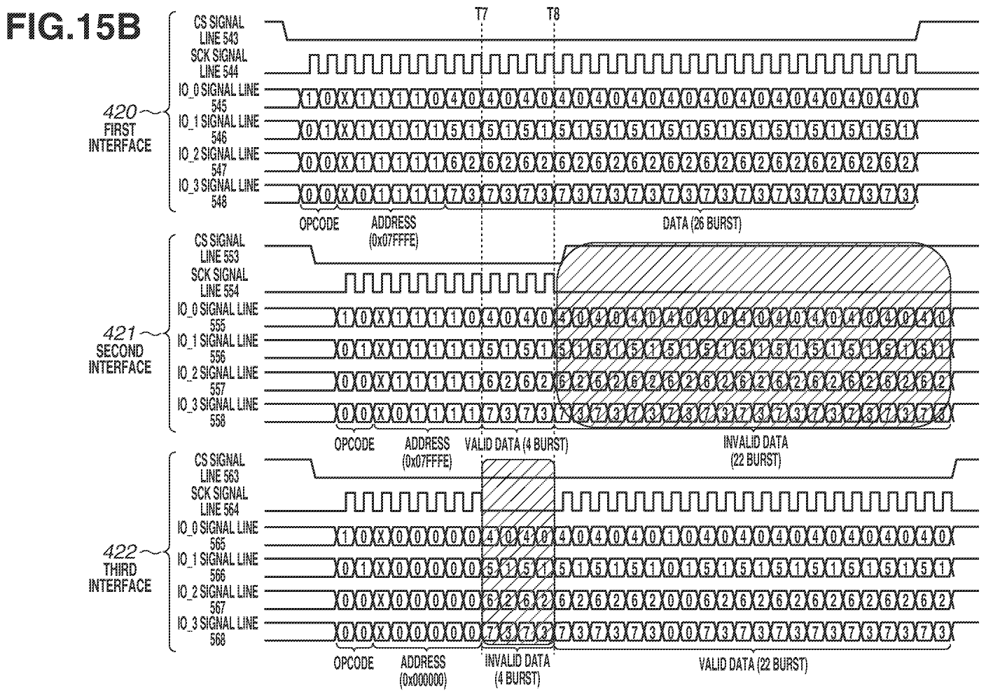

Next, the processing of the bridge device 411 according to the third exemplary embodiment when the master device 410 performs a write access will be described with reference to FIGS. 15A and 15B. FIG. 15A is a timing chart illustrating the operation of the bridge device 411 in a case where the address output from the master device 410 is an address more than four bytes before the last address of the first memory device 412. In other words, FIG. 15A is a timing chart in a case where there are more than eight clocks between when a master circuit starts to access a memory device and the timing when the memory device to be accessed is switched.

FIG. 15A illustrates a case where the address designated by the master device 410 is an address nine bytes before the last address of the first memory device 412, i.e., there are 18 clocks before the memory device to be accessed is switched.

At time T0, the master device 410 initially asserts the CS signal, and then starts to output the opcode. Like the second exemplary embodiment, the signal input from the master device 410 starts to be output from the first and second master circuits 502 and 503 at time T1 with a delay of two clocks.

The signal input from the master device 410 is input to the address analysis circuit 504 with a delay of one clock after the output of the signal from the master device 410. The 19th bit of the address output from the master device 410 is thus input to the address analysis circuit 504 at time T2. The address analysis circuit 504 refers to the value of the 19th bit and determines which of the first memory device 412 and the second memory device 413 is a memory device to communicate with. At time T3, the address analysis circuit 504 controls the master circuit connected to the memory device other than the one designated by the address input from the master device 410 to output its initial address.

At time T4, the address analysis circuit 504 instructs the second master circuit 503 connected to the second memory device 413 that is not the access destination to negate the CS signal.

At time T5, to switch the memory device to write the data received from the master device 410, the address analysis circuit 504 controls the second master circuit 503 to assert the CS signal and set the opcode and the initial address.

At time T6, the first master circuit 502 completes writing data to the last address of the first memory device 412, negates the CS signal, and ends the communication with the first memory device 412. From time T6 on, the data input from the master device 410 to the bridge device 411 is written to the second memory device 413.

FIG. 15B is a timing chart illustrating an operation when the number of clocks between when the master device 410 starts an access at a designated address and when the memory device to be accessed is switched is eight or less. In FIG. 15B, the second memory device 413 starts being accessed within eight clocks after the first master circuit 502 ends setting an address to the first memory device 412. If the second master circuit 503 has stopped accessing the second memory device 413, the data to be written to the second memory device 413 starts to be output while the opcode and the address are being set again. In FIG. 15B, the second master circuit 503 therefore stops outputting the clock signal at time T7 after the address is output. The second master circuit 503 then resumes outputting the clock signal to the second memory device 413 at time T8 after the last address of the first memory device 412 is accessed by the first master circuit 502. In such a manner, the memory device to be accessed can be switched without the second master circuit 503 negating the CS signal output to the CS signal line 563.

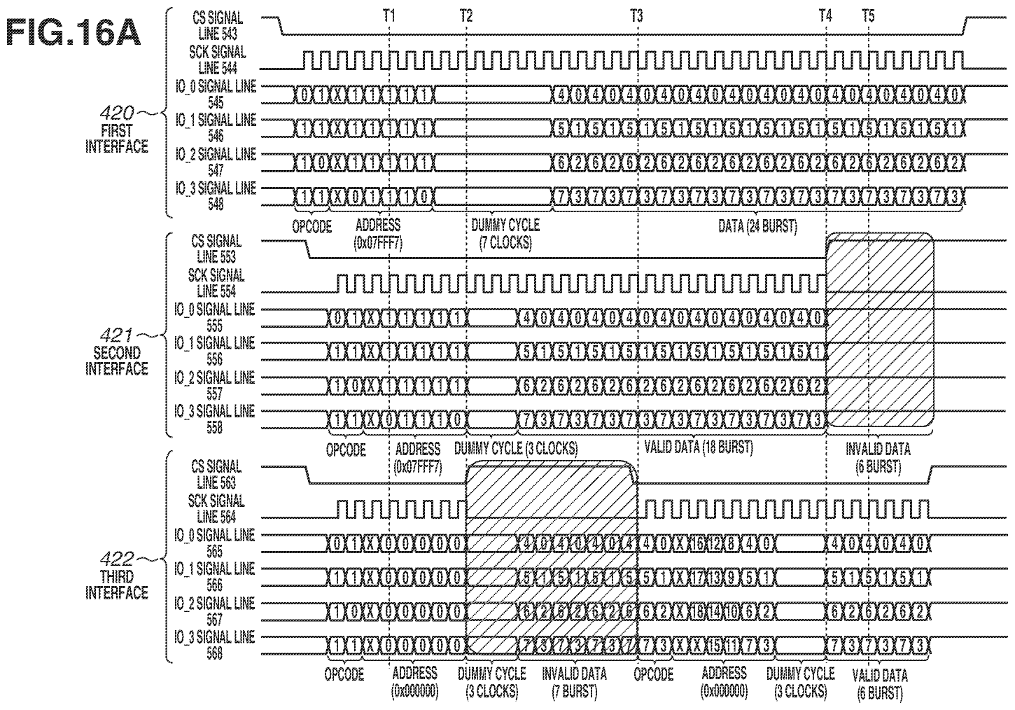

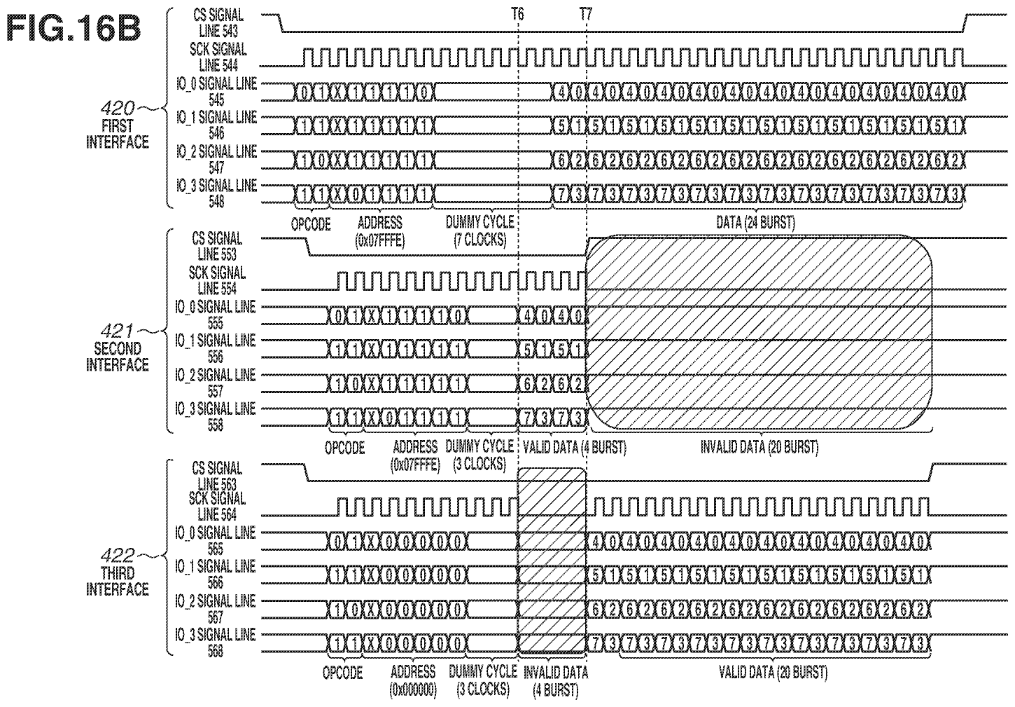

Next, processing in a case where the master device 410 outputs a read command will be described with reference to FIGS. 16A and 16B. In the case of a read command, data acquisition takes time as much as a dummy cycle (in the present exemplary embodiment, three clocks) in addition to the setting of an opcode and address. Processing is therefore switched depending on whether there are 11 clocks between when an access is started at the address designated by the master device 410 and when the memory device to be accessed is switched.

FIG. 16A illustrates the case where the number of clocks before the switching of the access destination is more than 11. At time T1, like when a write command is received, the initial address of the second memory device 413 to not be accessed by the address designated by the master device 410 is set to the second memory device 413. At time T2, the second master circuit 503 negates the CS signal and ends communication with the second memory device 413. The address analysis circuit 504 instructs the second master circuit 503 to assert the CS signal at time T3 that is 12 clocks before time T4 that in turn is immediately before when the master device 410 outputs data read from the second memory device 413. At time T3, the second master circuit 503 starts to set the opcode and the initial address to the second memory device 413. At time T4 when the memory device to be read is switched, the first master circuit 502 negates the CS signal and ends accessing the first memory device 412. Meanwhile, the second master circuit 503 starts obtaining read data from the second memory device 413. At time T5, the slave circuit 501 outputs the read data obtained from the second master circuit 503 to the master device 410.

FIG. 16B illustrates processing in the case where the number of clocks between when data read is started at the address designated by the master device 410 and when the memory device to be accessed is switched is 11 or less. As in FIG. 16A, it takes 11 clocks for a master circuit to obtain data after the output of the opcode. At time T6, the second master circuit 503 connected to the second memory device 413 other than the first memory device 412 selected by the address designated by the master device 410 gates the clock signal. At time T7, the second master circuit 503 cancels the gating of the clock signal to resume outputting the clock signal. In such a manner, the memory device to be accessed can be switched without the second master circuit 503 setting the opcode and the address again.

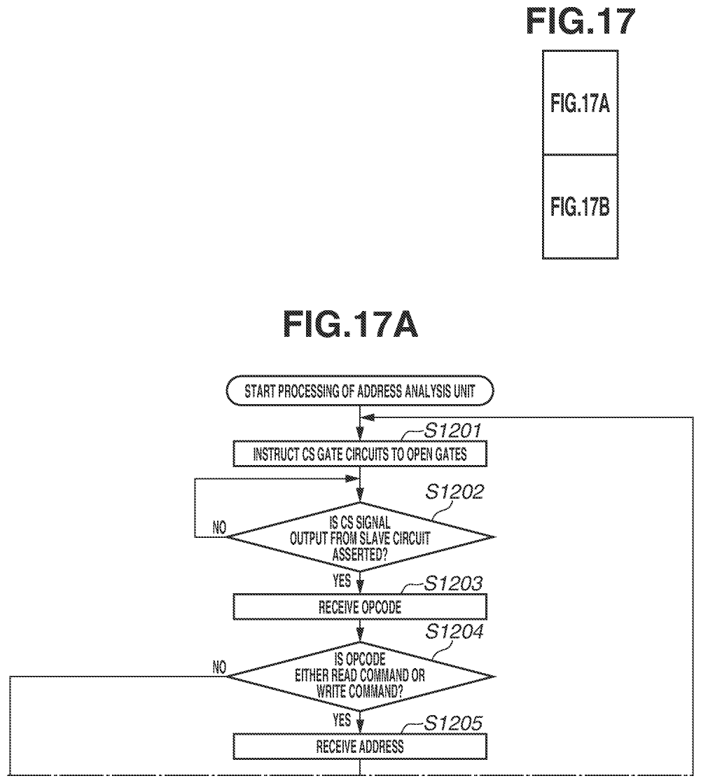

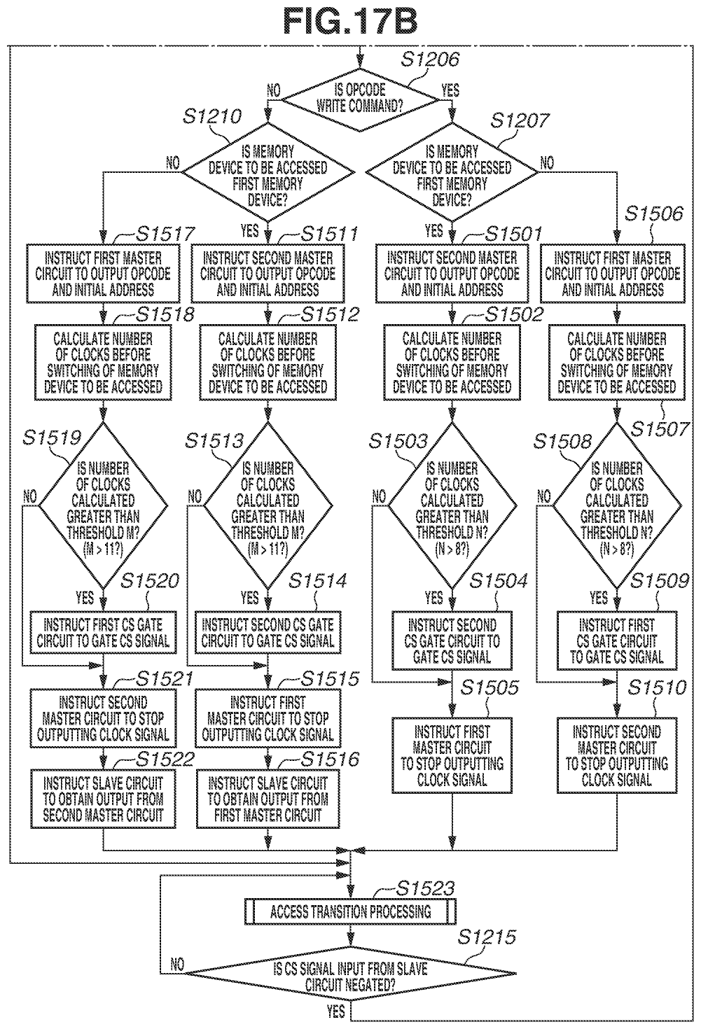

FIG. 17 including FIGS. 17A and 17B is a flowchart illustrating processing performed by the address analysis circuit 504 according to the third exemplary embodiment. Similar processes to those of the second exemplary embodiment are designated by the same reference numerals. Only different processes will be described here. The CPU 1110 may implement the processing illustrated in FIG. 17 by executing a program.

In step S1501, the address analysis circuit 504 instructs the second master circuit 503 communicating with the second memory device 413 to not be accessed to output the opcode and the initial address of the second memory device 413 to the second memory device 413.

In step S1502, the address analysis circuit 504 calculates how many more clocks remains before the switching of the memory device to be accessed. The address analysis circuit 504 calculates how many more bytes of access can be continuously made by subtracting the address designated by the master device 410 from the initial address of the next memory device to be accessed. Since the master device 410 can read one byte of data in two clocks, the address analysis circuit 504 multiplies the remaining number of continuously readable bytes by two to determine the number of clocks before switching.

In step S1503, the address analysis circuit 504 determines whether the number of clocks calculated in step S1502 is greater than a threshold N. In the present exemplary embodiment, the threshold N for situations where the master device 410 outputs a write command is 8. The threshold N may be variable based on the number of digits of the address.

If the number of clocks (hereinafter, referred to as a timing value) calculated in step S1502 is greater than the threshold N (YES in step S1503), the processing proceeds to step S1504. In step S1504, the address analysis circuit 504 instructs the second CS gate circuit 506 to gate the CS signal. Meanwhile, if the timing value calculated in step S1502 is eight or less (NO in step S1503), the processing skips step S1504 and proceeds to step S1505.

In step S1505, the address analysis circuit 504 instructs the second master circuit 503 to stop outputting the clock signal. The processing then proceeds to step S1523 to be described below.

If, in step S1207, the address designated by the master device 410 is an address in the second memory device 413 (NO in step S1207), the processing proceeds to step S1506. In step S1506, the address analysis circuit 504 instructs the first master circuit 502 to output the opcode and the initial address of the first memory device 412. In step S1507, the address analysis circuit 504 calculates the timing value for switching the access destination to the next memory device. The method for calculating the timing value is similar to that of step S1502. In step S1508, the address analysis circuit 504 determines whether the timing value calculated in step S1507 is greater than the threshold N. The threshold N in step S1507 is 8. If the timing value is greater than 8 (YES in step S1508), the processing proceeds to step S1509. In step S1509, the address analysis circuit 504 instructs the first CS gate circuit 505 to gate the CS signal output from the first master circuit 502. The processing proceeds to step S1510.

If the timing value is less than or equal to the threshold N (NO in step S1508), the processing proceeds to step S1510. In step S1510, the address analysis circuit 504 instructs the first master circuit 502 to stop outputting the clock signal.

If, in step S1210, the memory device to be accessed is determined to be the first memory device 412 (YES in step S1210), the processing proceeds to step S1511. In step S1511, the address analysis circuit 504 instructs the second master circuit 503 to output the opcode and the initial address of the second memory device 413.

In step S1512, the address analysis circuit 504 calculates the timing to access the next memory device. Here, the address analysis circuit 504 calculates a timing value by adding the number of dummy clocks to the value determined by the method described in step S1502.

In step S1513, the address analysis circuit 504 determines whether the timing value calculated in step S1512 is greater than a threshold M. In the present exemplary embodiment, the threshold M is 11. The value of the threshold M varies depending on the number of clocks needed to output an address and the number of dummy clocks. If the timing value is greater than 11 (YES in step S1513), the processing proceeds to step S1514. In step S1514, the address analysis circuit 504 instructs the second CS gate circuit 506 to gate the CS signal. The processing proceeds to step S1515.

If the timing value is less than or equal to the threshold M (NO in step S1513), the processing proceeds to step S1515. In step S1515, the address analysis circuit 504 instructs the second master circuit 503 to stop outputting the clock signal. In step S1516, the address analysis circuit 504 instructs the slave circuit 501 to obtain output from the first master circuit 502.

If, in step S1210, the memory device to be accessed is determined to be the second memory device 413 (NO in step S1210), the processing proceeds to step S1517. In step S1517, the address analysis circuit 504 instructs the first master circuit 502 to output the opcode and the initial address of the first memory device 412. In step S1518, the address analysis circuit 504 calculates the timing value for switching to the next memory device. The method by which the address analysis circuit 504 calculates the timing value is similar to that of step S1512. In step S1519, the address analysis circuit 504 determines whether the timing value calculated in step S1518 is greater than the threshold M. If the timing value is greater than the threshold M (YES in step S1519), the processing proceeds to step S1520. In step S1520, the address analysis circuit 504 instructs the first CS gate circuit 505 to gate the CS signal. The processing proceeds to step S1521.

If the timing values is less than or equal to the threshold M (NO in step S1519), the processing proceeds to step S1521. In step S1521, the address analysis circuit 504 instructs the first master circuit 502 to stop outputting the clock signal. In step S1522, the address analysis circuit 504 instructs the slave circuit 501 to obtain output from the second master circuit 503.

In step S1523, the address analysis circuit 504 having completed the foregoing processing performs access transition processing.

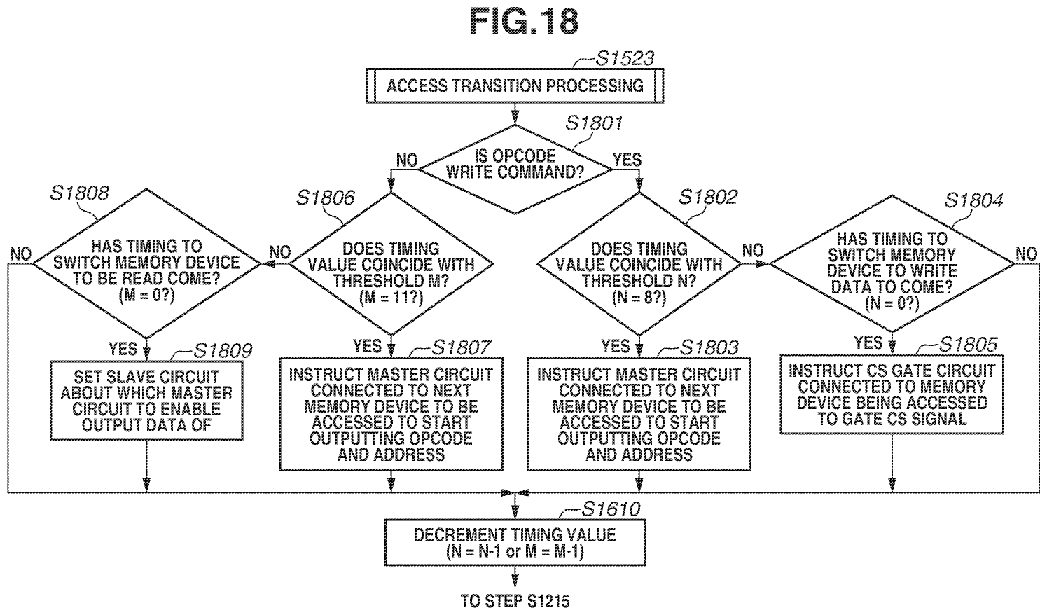

Next, the access transition processing that the address analysis circuit 504 performs in step S1523 will be described with reference to FIG. 18.

In step S1801, the address analysis circuit 504 determines whether the opcode output from the master device 410 is a write command. If the opcode is a write command (YES in step S1801), the processing proceeds to step S1802. In step S1802, the address analysis circuit 504 determines whether the timing value coincides with the threshold N. If the timing value coincides with the threshold N (YES in step S1802), the processing proceeds to step S1803. In step S1803, the address analysis circuit 504 instructs the master circuit connected to the next memory device to be accessed to start outputting the opcode and address. If the timing value does not coincide with the threshold N (NO in step S1802), the processing proceeds to step S1804. In step S1804, the address analysis circuit 504 determines whether the timing to switch the memory device to write data has come. If the timing to switch the memory device has come (YES in step S1804), the processing proceeds to step S1805. In step S1805, to start writing to the next memory device, the address analysis circuit 504 instructs the CS gate circuit connected to the memory device being accessed to gate the CS signal. If the clock signal output from the master circuit connected to the next memory device to be accessed is gated, the address analysis circuit 504 further cancels the gating of the clock signal.

If the access from the master device 410 is a read access (NO in step S1801), the processing proceeds to step S1806. In step S1806, the address analysis circuit 504 determines whether the timing value coincides with the threshold M. If the timing value coincides with the threshold M (YES in step S1806), the processing proceeds to step S1807. In step S1807, the address analysis circuit 504 instructs the master circuit connected to the next memory device to be accessed to output the opcode and address. If the timing value does not coincide with the threshold M (NO in step S1806), the processing proceeds to step S1808. In step S1808, the address analysis circuit 504 determines whether the timing to switch the memory device to be read has come. The timing to switch the memory device to be read refers to the timing when either master circuit accesses the last address of the corresponding memory device.

If the timing to switch the memory device to be accessed has come (YES in step S1808), the processing proceeds to step S1809. In step S1809, the address analysis circuit 504 instructs the CS gate circuit connected to the memory device to end access to gate the CS signal. The address analysis circuit 504 further sets the slave circuit 501 whether to enable data output from each master circuit.

In step S1810, the address analysis circuit 504 decrements the timing value by one. The processing then proceeds to step S1215 of FIG. 17.

If the master device 410 makes an access across a plurality of memory devices, the bridge device 411 according to the third exemplary embodiment, which performs the processing illustrated in FIGS. 17 and 18, can access the next memory device without interrupting the access from the master device 410.

An exemplary embodiment of the present invention can be implemented by performing the following processing. The processing includes supplying software (program) for implementing the functions of the foregoing exemplary embodiments to a system or an apparatus via a network or various storage media, and reading and executing the program code (program) by a computer (or CPU or microprocessing unit (MPU)) of the system or apparatus. In such a case, the computer program and a storage medium storing the computer program constitute the present exemplary embodiment.

A bridge device according to an exemplary embodiment of the present invention can select which memory device to connect by using a memory address input after assertion of a chip select signal by a master device.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-163190, filed Aug. 31, 2018, which is hereby incorporated by reference herein in its entirety.

What is claimed is:

1. A bridge device connected to a master device and a plurality of memory devices, the bridge device comprising:
a reception unit configured to receive a command for controlling a memory device, a memory address in the memory device, and data via a same signal line, the command, the memory address, and the data being output from the master device;
an output unit configured to output the command received by the reception unit to at least one of the memory devices; and
a selection unit configured to select a memory device to perform processing of the command received by the reception unit from among the plurality of memory devices based on the memory address received from the master device by the reception unit.

2. The bridge device according to claim 1, further comprising a control unit configured to perform control in such a manner that a chip select signal to be input to the memory device selected by the selection unit is asserted while the memory device selected by the selection unit performs the processing based on the command received via the reception unit.

3. The bridge device according to claim 1, further comprising an identification unit configured to identify the memory address in the memory device using a signal that the reception unit receives based on a clock signal output from the master device, and
wherein the selection unit is configured to select a memory device to be accessed based on the memory address identified by the identification unit.

4. The bridge device according to claim 3, wherein the identification unit is configured to identify the memory address using the signal received by the reception unit, based on a number of clocks input after the chip select signal is asserted by the master device.

5. The bridge device according to claim 1, wherein the selection unit is configured to select one of the plurality of memory devices based on a value of a predetermined bit of the memory address received from the master device by the reception unit.

6. The bridge device according to claim 1, wherein consecutive memory addresses are assigned to the plurality of memory devices.

7. The bridge device according to claim 1, wherein the output unit is configured to output the command and the memory address received by the reception unit to a same signal line.

8. The bridge device according to claim 7, wherein the output unit is configured to output the memory address to the memory device selected by the selection unit without changing the memory address received by the reception unit.

9. The bridge device according to claim 7, wherein the bridge device is configured to communicate with a memory device configured to access a location instructed by a least significant bit to a predetermined bit of the memory address output from the output unit.

10. The bridge device according to claim 1,
wherein the master device and the bridge device input and output data in compliance with a Serial Peripheral Interface (SPI) standard, and
wherein the master device and the memory device selected by the selection unit also input and output data in compliance with the SPI standard.

11. The bridge device according to claim 1, further comprising:
a control unit configured to assert chip select signals each corresponding to a different one of the plurality of memory devices, based on assertion of a chip select signal output from the master device; and
a gate unit configured to gate the chip select signals asserted by the control unit,
wherein the gate unit is configured to gate the chip select signal input to a memory device not selected by the selection unit from among the chip select signals asserted by the control unit, based on selection by the selection unit.

12. The bridge device according to claim 11, wherein the gate unit includes a logic circuit.

13. The bridge device according to claim 1,
wherein the reception unit is configured to receive data to be written to any one of the plurality of memory devices from the master device, and
wherein the output unit is configured to output the data received by the reception unit to the memory device selected by the selection unit.

14. The bridge device according to claim 13,
wherein the reception unit is configured to continuously receive data to be written to the memory devices, and
wherein the output unit is configured to continuously output the data continuously received by the reception unit.

15. The bridge device according to claim 13, wherein the output unit is configured to start outputting data to be written to a memory device other than the memory device selected by the selection unit after outputting data to be written to a final memory address of the memory device selected by the selection unit.

16. The bridge device according to claim 15, wherein the output unit is configured to output an initial memory address of the memory device other than the memory device selected by the selection unit to the other memory device before outputting the data to be written to the final memory address of the memory device selected by the selection unit.

17. The bridge device according to claim 1, further comprising a transmission unit configured to transmit data read from the memory device selected by the selection unit to the master device, based on a read command received from the master device.

18. The bridge device according to claim 17, wherein the transmission unit is configured to transmit data continuously read from a location designated by the memory address received by the reception unit to the master device.

19. The bridge device according to claim 18, wherein the output unit is configured to output an initial memory address of a memory device other than the memory device selected by the selection unit to the other memory device before data read from a last memory address of the memory device selected by the selection unit is input.

20. An information processing apparatus comprising a bridge device connected to a master device and a plurality of memory devices, the bridge device comprising:
a reception unit configured to receive a command for controlling a memory device, a memory address in the memory device, and data via a same signal line, the command, the memory address, and the data being output from the master device;
an output unit configured to output the command received by the reception unit to at least one of the memory devices; and
a selection unit configured to select a memory device to perform processing of the command received by the reception unit from among the plurality of memory devices based on the memory address received from the master device by the reception unit.
